(19) United States
(12) Patent Application Publication
(10) Pub. No.: US 2025/0256454 A1
(43) Pub. Date: Aug. 14, 2025

(54) METHOD FOR PRODUCING AN OPTICAL ELEMENT BY PROCESSING AN OPTICALLY REACTIVE MATERIAL, AND OPTICAL ELEMENT

(71) Applicant: XOLO GMBH, Berlin (DE)

(72) Inventors: DIRK RADZINSKI, Berlin (DE); YVES GARMSHAUSEN, Berlin (DE); MARTIN HERDER, Berlin (DE); NIKLAS KÖNIG, Berlin (DE); MARCUS REUTER, Berlin (DE)

(73) Assignee: XOLO GMBH, Berlin (DE)

(21) Appl. No.: 19/104,772

(22) PCT Filed: Feb. 27, 2024
(86) PCT No.: PCT/EP2024/054991

§ 371 Date: Feb. 19, 2025

(30) Foreign Application Priority Data
Feb. 28, 2023 (DE) 10 2023 104 907.0

(51) Int. Cl. B29C 64/129; B29C 64/30; B29K 105/00; B29L 11/00; B33Y 10/00; B33Y 40/20; B33Y 80/00

(52) U.S. Cl. CPC B29C 64/129; B29C 64/30; B33Y 10/00; B33Y 40/20; B33Y 80/00; B29K 2105/0002; B29L 2011/00

(57) ABSTRACT

Method for producing an optical element by processing an optically reactive material.

The invention relates to a method for producing an optical element by processing an optically reactive material, and to an optical element produced by means of the method, a corresponding device, and an optical element produced according to the method.

### BACKGROUND

Subtractive methods for producing optical elements, for example milling, grinding and polishing workpieces, are time-consuming and costly. Other shaping methods, such as precision blank pressing of glass, or injection molding of polymer materials, are associated with increased manufacturing tolerances and high initial costs for the die production. In contrast, additive manufacturing processes offer the advantage of material, time and cost-saving production of any three-dimensional bodies.

Optical elements can be additively manufactured by means of various methods, for example stereolithography or digital light processing. In the case of both methods, however, it is always the case that only layer-wise construction is possible, due to the process. Furthermore, only low-viscosity materials can be used since these have to flow well. In the case of layer thicknesses between 10 μm and 100 μm, this is always associated, for curved surfaces, in a loss of geometric accuracy. Furthermore, the layer-wise construction leads to density inhomogeneities and thus to inhomogeneity of the optical and mechanical properties within the component. The layer-wise construction of these methods is furthermore always associated with long waiting times in the individual process steps, and thus leads to long process times. Lastly, in the case of the mentioned methods, overhanging structural elements must be provided with support structures. The construction of these support structures is not only time-consuming and material-intensive and thus also costly, but rather the contact points between these support structures and the component furthermore still further reduce the surface quality of the components produced in this way. Although the surface quality can be further improved by post-processing steps, such as polishing or coatings, this is also associated with a loss of geometrical accuracy and, as a further process step, is both time-consuming and costly.

In the case of Continuous Liquid Interphase Production (CLIP, Nature Materials, 5, 365-369 (2006)), the installation space is irradiated from below through an oxygen-permeable membrane, as a result of which a chemical inhibition zone forms, which allows for a continuous construction of isotropic objects. Although this method is significantly quicker than the conventional stereolithography, it is still dependent on the flow behavior of the photo resins, as a result of which high-viscosity materials cannot be used, which are well suited for producing polymers having high mechanical strength. Furthermore, in this method it is not possible to omit support structures, which are associated with the above-mentioned disadvantages. Furthermore, there are chemical limitations with respect to the resin since the oxygen inhibition does not function in the case of cationic polymerization or thiol-ene resins. Finally, some additives such as bases cannot be used since these counteract the oxygen inhibition.

The document WO2014/108364 A1 discloses a multi-jetting method in which a layer of small liquid drops of photo resin is deposited in a precisely located manner on a surface, and subsequently cured by UV irradiation. Careful control of the wetting properties makes it possible for the natural curvature of the individual trop surfaces to be used, in order to achieve very high surface qualities, although the construction is layer-wise here too. However, due to the process, in this case low-viscosity materials are also used, and in this method it is still only possible to freely form an optical surface which further undergoes restrictions with respect to the printable angle and other geometry limitations.

The document DE 10 2020 108 375 B3 discloses a method for producing an intraocular lens, having the following steps: providing a container which is transparent for electromagnetic radiation and in which a liquid is arranged which can be cured using the electromagnetic radiation; irradiating the liquid with a set of images which are formed by the electromagnetic radiation and which each show an intraocular lens, wherein each of the images of the set is irradiated into the liquid at a different irradiation angle with respect to a reference plane extending through the liquid, as a result of which the liquid is cured and the cured liquid forms the intraocular lens. The method is limited insofar as no highly anisotropic structures or sharp edges can be formed, as a result of which the structural freedom is limited.

For producing optical elements, starting materials can be optically processed by means of irradiation of light of one or more wavelengths onto the starting material, in order to thereby change at least one material property of the starting material. It is thus for example known per se to cure a starting material with the aid of optical processing of this kind.

The document U.S. Pat. No. 4,041,476 describes a method and a device by means of which a three-dimensional body can be produced from a starting material in that light beams of different wavelengths are irradiated onto the starting material and overlap at points in the process.

Polymerization is a reaction that is used for producing plastics materials. In polymerization, which is a form of optical processing of a starting material, the reaction is triggered by means of irradiation of light onto the polymerizable starting material. Such polymerizable starting substances or materials are also referred to as photopolymers. These are polymers that change their material properties when irradiated with light. The light irradiation brings about structural changes, for example photochemical curing of the material by cross-linking. Photopolymerization is used for example in 3D printing, in order to produce three-dimensional shaped bodies, in the polymerizable starting material, from the cured material.

The starting material itself can be transparent, and thus insensitive, for the irradiated light. Photoinitiator molecules are mixed in, which absorb the light and initiate the curing of the starting material. For processing the starting material in the unchanged (free) volume, it is necessary to address a freely selected point in 3-dimensional space. One possibility is to use special photoinitiators which are also referred to as dual-color photoinitiators (WO 2020/245 456 A1 and WO 2021/089 090 A1). These are preferably or exclusively excited by absorption of photons of two different wavelengths or two different, non-overlapping wavelength ranges. Dual-color photoinitiators can be created in different ways. In one variant, molecules have a basic/normal state (A) without irradiation of light. In this state, the molecule has an absorption band for a wavelength A1 and the smallest possible absorption at another wavelength A2.

The molecules can then assume a pre-activated or excited intermediate state (B). The pre-activated or excited intermediate state is created by absorption of light of the wavelength λ₁ from the basic state A. In the intermediate state B the photoinitiator molecules have an absorption band for the wavelength λ₂. The absorption band for the wavelength λ₁ disappears. Alternatively, the absorption band for the wavelength λ₁ is retained. This results in an undesired, competing transition channel to state C. In the absence of light, the photoinitiator molecule returns to the state A. Alternatively, the photoinitiator molecule returns to the state A after excitation with light of a third wavelength λ₃. This allows for targeted inhibition of the initiator in state B.

The active state C of the molecules is created from B by absorption of the wavelength λ₂. The state C sets in motion a chemical and/or physical modification of the immediate surroundings of the molecule. A back reaction to B is not provided, but is possible.

### SUMMARY

The problem addressed by the invention is that of specifying a method for producing an optical element by processing an optically reactive material, by means of which a starting material can be optically processed in a multi-dimensional manner in an efficient manner.

As the solution, a method for producing an optical element by processing an optically reactive material and an optical element according to the independent claims are provided. Dependent claims relate to embodiments.

According to one aspect, a method for producing an optical element by processing an optically reactive material is provided, which method comprises the following: providing a starting material which is optically reactive and fills a working volume; optically processing the starting material in the working volume by way of irradiation of light of a first wavelength and light of a second wavelength that is different from the first wavelength, wherein at least one material property of the starting material is changed by way of the optical processing. The optical processing comprises the following: irradiating a first layer partial volume of the working volume filled with the starting material with the light of the first wavelength; irradiating the first layer partial volume of the working volume with the light of the second wavelength, wherein the light of the second wavelength is in this case projected into the working volume; irradiating a second layer partial volume of the working volume filled with the starting material, which is different from the first layer partial volume, with the light of the first wavelength; irradiating the second layer partial volume of the working volume with the light of the second wavelength, wherein the light of the second wavelength is in this case projected into the working volume; and repeating the preceding steps for layer-wise optical processing of the starting material in the working volume until a volume of the starting material to be processed, which is gathered entirely or in part by the working volume, is optically processed, and in the process a green body is formed from the starting material; and further processing the green body, such that an optical element is formed at least in part, in particular completely, from the green body.

The method in particular comprises the following: providing a starting material which is optically reactive and fills a working volume; optically processing the starting material in the working volume by way of irradiation of light of a first wavelength and light of a second wavelength that is different from the first wavelength, wherein the light of the first wavelength and the light of the second wavelength are provided by a lighting device, and wherein at least one material property of the starting material is changed by way of the optical processing. The optical processing comprises the following: irradiating a first layer partial volume of the working volume filled with the starting material with the light of the first wavelength; irradiating the first layer partial volume of the working volume with the light of the second wavelength, wherein the light of the second wavelength is in this case projected, by a projection device, into the working volume in a manner that hits only first layer partial volume entirely or in part; irradiating a second layer partial volume of the working volume filled with the starting material comprising the starting material, which is different from the first layer partial volume, with the light of the first wavelength; irradiating the second layer partial volume of the working volume with the light of the second wavelength, wherein the light of the second wavelength is in this case projected, by a projection device, into the working volume in a manner that hits only the second layer partial volume entirely or in part; and repeating the preceding steps for layer-wise optical processing of the starting material in the working volume until a volume of the starting material to be processed, which is gathered entirely or in part by the working volume, is optically processed, and in the process a green body (blank) is formed from the starting material; and further processing the green body, such that an optical element is formed (at least in part, in particular completely) from the green body.

According to a further aspect, an optical element is provided which is produced by means of the method.

The method makes it possible to produce an optical element in an efficient manner. In this case, the starting material, which is already introduced into and fills the working volume before the irradiation of the light of the first and second wavelength, can be optically processed in the working volume in a multi-dimensional or spatial manner, such that at least one material property of the starting material is changed by means of irradiation of the light of the first and second wavelength, selectively by light of one or more further wavelengths, and an optical element is obtained by further processing (post-processing). By means of the method, a volumetric 3D printing process can be provided, which can in particular run continuously and can thus allow for the production of isotropic objects.

In this case, the invention proceeds from the surprising finding that volumetric 3D printing methods, which include irradiating corresponding layer partial volumes with light of a first and a second wavelength, are excellently suited for producing optical elements. In particular, optical element having excellent properties and of high quality can be produced in an efficient manner using corresponding volumetric 3D printing methods, which include irradiating corresponding layer partial volumes with light of a first and a second wavelengths. The invention thus breaks with the view, prevalent to date, that optical elements, in particular large optical elements, cannot be produced, having desired properties, using volumetric 3D printing methods; in particular, it has been possible to show, on the basis of studies, that e.g. the CT-based axial lithography (computed axial lithograph), CAL method for short, is not suitable, in particular because this method is suitable only to a limited extent for producing microoptics or leads to component surfaces that contain artefacts, which exclude the use of the printed component as an optical element. In other words, the inventors were able to find that it is nonetheless surprisingly possible to use certain volumetric 3D printing methods, specifically in particular volumetric 3D printing methods which include irradiation of corresponding layer partial volumes with two different wavelengths, for producing optical elements, in particular optical elements from polymer materials or plastics materials.

Furthermore, a device for processing an optically reactive material is disclosed, which can comprise the following: a working volume, which is configured for receiving a starting material which is optically reactive and fills the working volume in part or completely; a lighting device, which is configured to provide light of a first wavelength and light of a second wavelength for irradiation onto the working volume comprising the starting material. The lighting device can be configured to optically process the starting material in the working volume as follows: irradiating a first layer partial volume of the working volume filled in part or completely with the starting material with the light of the first wavelength; irradiating the first layer partial volume of the working volume with the light of the second wavelength, irradiating a second layer partial volume of the working volume, which is different from the first layer partial volume, with the light of the first wavelength; irradiating the second layer partial volume of the working volume with the light of the second wavelength; and repeating the preceding steps for layer-wise optical processing of the starting material in the working volume until a volume of the starting material to be processed, which is gathered entirely or in part by the working volume, is optically processed, in particular forming a corresponding green body.

The device can in particular comprise the following: a working volume, which is configured for receiving a starting material which is optically reactive and fills the working volume; a lighting device, which is configured to provide light of a first wavelength and light of a second wavelength for irradiation onto the working volume comprising the starting material; and a projection device which is configured for projecting the light of the second wavelength upon irradiation onto the working volume filled with the starting material, in a layer partial volume of the working volume and catching only the layer partial volume, completely or in part. The lighting device and the projection device can furthermore be configured to optically process the starting material in the working volume as follows: irradiating a first layer partial volume of the working volume filled with the starting material with the light of the first wavelength; irradiating the first layer partial volume of the working volume with the light of the second wavelength, wherein the light of the second wavelength is in this case projected, by a projection device, into the working volume in a manner that hits only first layer partial volume entirely or in part; irradiating a second layer partial volume of the working volume filled with the starting material comprising the starting material, which is different from the first layer partial volume, with the light of the first wavelength; irradiating the second layer partial volume of the working volume with the light of the second wavelength, wherein the light of the second wavelength is in this case projected, by a projection device, into the working volume in a manner that hits only the second layer partial volume entirely or in part; and Repeating the preceding steps for layer-wise optical processing of the starting material in the working volume until a volume of the starting material to be processed, which is gathered entirely or in part by the working volume, is optically processed, and in the process a green body is formed from the starting material. An optical element can be formed (at least in part, in particular completely) from the green body by further processing.

The lighting device, also referred to herein as the irradiation device, of the device can be configured to create a light section in the working volume or can comprise a light section creation device for creating a light section in the working volume.

The lighting device can comprise e.g. one of the following elements: a Powell lens, a cylinder lens, in particular a planoconvex cylinder lens, or a polygon mirror or a galvo scanner. Alternatively or additionally, the lighting device can e.g. comprise: a laser or an LED or a thermal light source.

Alternatively or additionally, the lighting device can e.g. comprise: a mirror or a light deflection device, which are configured to irradiate the light, which emerges from the working volume, back into the working volume in the opposite direction, by reflection.

The lighting device can be configured to allow earlier processing, in the temporal course, of layers that are located further from a source of the light of the second wavelength.

The layer partial volumes of the working volume are irradiated in succession with the first and the second wavelength, in order to thus trigger an optically initiated reaction in the starting material. The layer partial volumes, which are optically processed in succession, contain partial volumes of the starting material which is introduced into the working volume before the start of the manufacturing process (optical processing), and are filled thereby. In contrast to known methods, in the case of optical processing no layer-wise application of the starting material takes place, and respectively subsequent layer-wise optical processing (of the just-applied layer) after the layer application.

Depending on what layer partial volume is irradiated, within the working volume previously filled with the starting material, with the first wavelength, the projection of the light of the second wavelength or the irradiation with light of the second wavelength takes place with the aid of the projection device in precisely this layer partial volume that is at present and currently irradiated with the first wavelength. The projection device causes imaging of the light of the second wavelength into the currently desired layer partial volume. In this case, the projection device can image the light of the second wavelength of an at least two-dimensionally shaped image correspondingly in the projection plane or the projection volume, which is located in the layer partial volume irradiated with the light of the first wavelength. In this way, for example a three-dimensional body can be produced in the starting material, layer-by-layer.

The further processing of the green body can in particular comprise at least one of the following steps: removing the green body from the starting material; treating (in particular washing) the green body with a solvent and/or a (treatment) monomer; and drying the (washed) green body. The green body can be formed isotropically.

Alternatively, the further processing steps can take place in the starting material (without removing the blank).

The solvent and/or the (treatment) monomer can comprise a photoinitiator and/or a thermal initiator which preferably reacts only at one wavelength (or one wavelength range). In this way, the post-curing can take place more efficiently. In this case, the photoinitiator and/or thermal initiator can be configured to be received in the surface of the green body. In particular, a photoinitiator and/or thermal initiator can be dissolved in the solvent and/or the (treatment) monomer. The drying can take place for example by means of supplying a gas stream (preferably an airstream or a nitrogen stream) and/or by supply of heat (preferably of a temperature of at least 20° C.). Photoinitiators are described for example in Fouassier/Lalevée, Photoinitiators, Wiley-VCH (2021).

In particular for high-viscosity starting materials, the washing can result from corresponding selection of the solvent or (treatment) monomer, time, temperature, and movement of smoother surfaces of the green body.

In addition or alternatively, the further processing of the green body can comprise at least one of the following steps: photochemical post-curing of the green body, tempering the green body (this typically corresponds to thermal post-curing of the green body), grinding the green body, polishing the green body, and coating the green body (for example with an antireflection coating).

Coating of the green body can take place using one or more chemical and/or physical coating methods, and can in particular serve to improve the surface properties of the green body and thus of the optical element. In particular, the roughness, scratch-resistance and/or reflective properties can be improved by applying at least one coating. It is thus the case, for all embodiments, that an applied coating can have a lower refractive index than the (actual) optical element (e.g. due to an antireflection coating) and/or the surface hardness of the optical element can increase (e.g. by an anti-scratch layer).

Corresponding coating methods can include e.g. a spray method, a dip method, a spin-coating method, a sol-gel method, or a gas-phase deposition method. After any coating, further curing—which can again take place e.g. photochemically or thermally, can be carried out.

A coating material to be applied by means of a corresponding coating method can be e.g. a solid, a paste, a liquid or a varnish, or a gas. Therefore, a coating material can be applied to the green body e.g. as powder, as paste, as liquid or as varnish, or as gas or from a gas phase.

A coating can also take place with the non-cured starting material itself or another organic polymer or an inorganic/organic hybrid material, which typically requires further curing, which can again take place e.g. photochemically or thermally.

The surface of the green body or of the optical element can be prepared chemically and/or physically before applying the coating, i.e. in particular be activated, in order to allow for better attachment of the coating. Corresponding processing or activation can take place using a plasma, in particular an oxygen plasma. Alternatively or in addition, adhesion promoters are also conceivable, which allow for better attachment of the coating to the green body or the optical element.

The photochemical post-curing can take place by means of isotropic irradiation of the green body (uniform irradiation from all sides, with light). The tempering or thermal post-curing can take place by means of supply of heat at temperatures of at least 50° C., in particular for a duration of at least 15 minutes, or corresponding aging of the green body in temperatures of at least 50° C., in particular for a duration of at least 15 minutes.

With the aid of a control device which is connected to one or more light sources or irradiation devices for providing the light of the first and the light of the second wavelength, and optionally the or a projection device, which can in general form a component of the irradiation device, it is possible to determine whether the first or the second layer partial volume (of the starting material in the working volume) is irradiated, and the projection device can be actuated, depending thereon, to project the light of the second wavelength into the first and/or the second layer partial volume. In this case, data are provided in the control device, which define the current or present position of the layer partial volume which is irradiated with light of the first wavelength. Proceeding herefrom, the projection device is controlled in such a way that the projection created with the aid of the projection device takes place in a projection plane or in a projection volume in said currently irradiated layer partial volume. In this way, the layer partial volumes of the starting material are processed layer-by-layer, in succession. In this case, the external shape of the projection of the projection device may be different for different layer partial volumes, in particular depending on a three-dimensional body which is intended to be produced in the starting material with the aid of the optical processing.

It can be provided in one embodiment to detect a current or present position of the layer partial volume, which is irradiated with the light of the first wavelength, in the working volume with the aid of a measuring device, which then provides measuring signals, indicating the position, to the control device.

The light of the first wavelength and the light of the second wavelength can be irradiated simultaneously and together into the first or the second layer partial volume, at least for a temporal overlap period. In this embodiment, the region gathered by the layer partial volume and the projection of the projection device is irradiated, at least for the temporal overlap region, both with light of the first wavelength and with light of the second wavelength.

The first and the second layer partial volume can form adjacent layer partial volumes of the starting material in the working volume.

It can be provided that the first and the second layer partial volume are formed corresponding to one of the following configurations of partial volumes: overlapping at the edge, abutting at the edge, and spaced apart from one another at the edge.

The light of the first wavelength can be irradiated along a first irradiation direction, and the light of the second wavelength is irradiated along a second irradiation direction which extends transversely to the first irradiation direction, onto the starting material in the working volume. In one embodiment, the first and the second irradiation direction can for example assume an angle of approximately 90°. Other angles can be provided in the range of approximately 30° to 90° between the optical axes of the irradiation directions.

The light of the first wavelength and/or the light of the second wavelength can be irradiated as pulsed light. The light pulses of the light of the first and second wavelength can be irradiated into the currently processed layer partial volume simultaneously or at a predetermined temporal spacing one after the other. The light pulses for the light of the two wavelengths can be provided having the same or different temporal pulse widths. Alternatively, the light of the first wavelength or the light of the second wavelength can be irradiated as continuous light.

The starting material can be processed by means of the optical processing in a manner corresponding to at least one processing method from the following group: curing, hardening, gelatinizing and liquifying. In these or other embodiments, the starting material can be solid, liquid or pasty.

In one embodiment it can be provided that the starting material is caused to glow on account of the optical processing with the light of the first and second wavelength, in particular on account of fluorescence or phosphorescence.

For irradiating the first layer partial volume and for irradiating the second layer volume with the light of the first wavelength, a layer-form irradiation region of a first light source, with which the light of the first wavelength is provided, can be displaced relative to the working volume. In this embodiment, the layer-form irradiation region for the light of the first wavelength is displaced relative to the starting material during the optical processing thereof, such that the irradiation region extends or sweeps quasi over the working volume. The relative movement between the working volume and the irradiation region can be achieved in various ways. A displacement of the working volume and/or of the first light source can be provided. Alternatively or in addition, the working volume and first light source can be fixed relative to one another during the entire processing of the starting material. With the aid of a light deflection device, the irradiation region for the light of the first wavelength from the first light source is moved over the working volume comprising the starting material.

It can be provided that the optical processing of the starting material is observed with the aid of one or more light detectors, for example by means of a camera and/or a photodetector. In this case, the procedures during processing (optical processing) can be studied, in that for example transmitted light is measured, whether this be light of the excitation of the light section and/or light from the projector. The light section generator and/or the projector can emit further light wavelengths which are different from the excitation wavelengths and serve only for observing the change in the material property of the starting material, for example the polymerization that is taking place.

A polychromic multi-photon polymerization (“xolography”) can be triggered in the starting material, by means of the optical processing, which causes the change in the at least one material property of the starting material. In one embodiment by way of example, the starting material can comprise a transparent organic polymer and/or an inorganic/organic polymer composite, which preferably cures by means of the optical processing. In one embodiment by way of example, the starting material can comprise one or more of the following components: oligomer (for example acrylate, methacrylate, epoxy, vinyl, allyl, organopolysiloxane, terminally functionalised polysiloxanes), functionalised and non-functionalised nanoparticle, monomer (for example acrylate, methacrylate, epoxy, vinyl, allyl), cross-linker (for example multifunctional monomers, multifunctional thiols), dual-color photoinitiator, co-initiator, inhibitor, sensitizer, defoamer, additive for post-processing (for example additional photoinitiator and/or thermal initiator), solvent, additive, in particular additive for rheology control (rheology modifier), in particular of the starting material, additive for reducing the surface tension, in particular of the starting material, additive for influencing the optical properties, for example for adjusting or increasing the transparency or adjusting the refractive index, in particular of the starting material or of the optical element.

The dual-color photoinitiator can react to light of two different wavelengths and in particular lead to local polymerization, which preferably results in selective curing. In one embodiment, a transparent vessel with monomer and dual-color photoinitiator can be irradiated from one side by a laser line, such that a light section results. A video can be projected onto the light section. A cured object can result in a free-floating manner by movement of the vessel.

The method can (preferably during the projection of the video) include performing a pixel shift, such that preferably automatic smoothing of the edges is achieved. Furthermore, dismantling of the object by software, into layers having layer thicknesses of <=1 μm at a uniform printing speed can be provided, as a result of which preferably a high resolution of the optical element is achieved.

The starting material can have a viscosity of 10² mPa·s to 10⁷ mPa·s, preferably of 3·10³ to 10⁶ mPa·s, particularly preferably of 10³ to 10⁵ mPa·s, most preferably of 10⁴ to 9·10⁴ mPa·s.

The starting material can comprise a monomer mixture and/or an oligomer mixture, preferably of a corresponding viscosity. The monomer mixture and/or oligomer mixture can preferably be transparent. The monomer mixture and/or oligomer mixture can stabilize the green body and/or a cured object, as a result of which in particular the need for support structures is omitted and there is complete structural freedom. The cured object can result in a free-floating manner in the monomer mixture and/or oligomer mixture.

In particular, the cured object, i.e. the green body, can result in a free-floating manner in the monomer mixture and/or oligomer mixture, i.e. in general in the starting material, if the monomer mixture or oligomer mixture, in general the starting material, has a sufficiently high viscosity, which supports the cured object. Alternatively or in addition, the cured object can result in a free-floating manner in the monomer mixture and/or oligomer mixture, in general in the starting material, if the monomer mixture or oligomer mixture, in general the starting material, has non-Newtonian flow properties, i.e. shear-thinning or shear-liquifying flow properties, and/or has a yield strength that is greater than the static shear loading by the object. The yield strength of the starting material can be found e.g. by rotational rheometry (plate-to-plate rheometer) under quasi static loading via a “creep test” or travelling a slow shearing stress ramp.

A corresponding yield strength of the starting material, which is greater than the static shear loading by the object, is typically greater than or equal to 0.1 Pa, in particular 0.2 Pa, more particularly 0.3 Pa, more particularly 0.4 Pa, more particularly 0.5 Pa, more particularly 0.6 Pa, more particularly 0.75 Pa, more particularly 1 Pa. A corresponding yield strength of the starting material can thus be in particular at least 0.1 Pa per cm³ of the working volume. For a working volume of 1 cm³, the yield strength of the starting material can thus be at least 0.1 Pa. For a working volume of 2 cm³, the yield strength of the starting material can thus be at least 0.2 Pa.

The static shear loading by the object depends in particular on the geometry and size of the object, and can accordingly, depending on the geometry and size of the object, be less than or greater than 0.5 Pa. In order to achieve corresponding rheological properties of the monomer mixture or the oligomer mixture, in general of the starting material, it may be expedient for the monomer mixture or the oligomer mixture, in general the starting material, to be stirred before the optical processing, i.e. before the printing. The starting material can thus, in particular after being filled into a container defining the working volume, be stirred for a given time, in particular of at least one hour, in particular at least six hours, more particularly at least twelve hours, more particularly at least eighteen hours, more particularly at least twenty hours.

Alternatively or in addition, a corresponding yield strength of the starting material can be set by mixing in oligomers and polymers having non-Newtonian flow properties and/or mixing in additives (rheology modifiers). Examples for oligomers having non-Newtonian flow properties are, in a non-exclusive listing: 1) linear polymers having average and/or high molar masses, e.g. PMMA, PS, PC, PIM, 2) celluloses and cellulose esters, 3) polyacrylic acids and polyacrylic acid/polyacrylic acid ester copolymers, 4) polyacrylamides, 5) polyethylene oxide, and 6) polyurethanes. Examples for rheology modifiers are, in a non-exclusive listing: 1) inorganic (nano)particles, e.g. pyrogenic silicic acid, natural and synthetic clay minerals, sheet silicates, glass, 2) organically modified inorganic (nano)particles, 3) organic molecules, oligomers and polymers (urea derivatives, polysaccharides, polyacrylic acids, polyacrylates, polyamides, polyethers, polyurethanes, polyurea derivatives), and 4) urea-modified polyacrylates, polyethers, polyamides and polyurethanes. Examples for commercial organic rheology modifiers which can be used are, in a non-exclusive listing: RHEOBYK 410, RHEOBYK 420, RHEOBYK 430, RHEOBYK 440, BYK-LP R21675, RHEOBYK 7410CA, RHEOBYK 7420CA, RHEOBYK 7420ET (all available from BYK-Chemie GmbH, 46486 Wesel (Germany)), JL-106 (available from Bomar Chem, 51 Greenwoods Rd, Torrington, CT 06790).

For any rheology modifier, it is preferably the case that this is selected and/or used, e.g. in view of its chemical and/or physical properties, concentration, etc., in such a way that it does not or barely leads to turbidity of the starting material and/or of the cured material after optical processing.

At this point, it should be noted in general that the starting material, in particular in a wavelength range between 370 and 800 nm, more particularly between 400 and 800 nm, more particularly between 450 and 800 nm, more particularly at 600 nm, typically has a transmission of at least 10%, in particular at least 20%, more particularly at least 30%, more particularly at least 40%, more particularly at least 50%, more particularly at least 60%, more particularly at least 70%, more particularly at least 80%, more particularly at least 90%, more particularly at least 95%, more particularly at least 99%, in the region of the irradiated light of the first wavelength and/or in the region of the irradiated light of the second wavelength. In this case, the optical transmission relates to an optical path length corresponding to the Beer-Lambert law of 10 mm.

At this point, it should also be noted in general that the optical element, in particular in a wavelength range between 370 and 800 nm, more particularly between 400 and 800 nm, more particularly between 450 and 800 nm, more particularly at 600 nm, can typically have a transmission of at least 10%, in particular at least 20%, more particularly at least 30%, more particularly at least 40%, more particularly at least 50%, more particularly at least 60%, more particularly at least 70%, more particularly at least 80%, more particularly at least 90%, more particularly at least 95%, more particularly at least 99%, in the region of the irradiated light of the first wavelength and/or in the region of the irradiated light of the second wavelength. In this case, the optical transmission relates to an optical path length corresponding to the Beer-Lambert law of 10 mm.

The terms “transparency” and “transmission” can be understood as equivalents herein.

It is generally the case that the starting material can exhibit non-Newtonian rheological behavior. Such rheological behavior can facilitate the production of an object in the case of illumination with at least two different wavelengths, wherein the object remains in a fixed position within the working volume or is not moved or is moved only minimally in the working volume during the formation. Such a minimal movement can relate to the displacement of the object during the formation in the working volume, which is acceptable for a precise production of the object. Such rheological behavior can also facilitate the separation of the partially produced object from the working volume when mechanical loads are applied. The viscosity or the apparent viscosity of the non-Newtonian starting material can drop to a lower value (e.g. the constant shear viscosity) than the static value (e.g. zero-shear viscosity or yield stress) in the case of action of mechanical load or shearing, such that the starting material can more easily flow (away) and separate from the object. Examples for such non-Newtonian rheological behavior are inter alia pseudoplastic behavior, Bingham behavior, shear-thickening behavior, and shear-thinning behavior.

A starting material can be provided with non-Newtonian rheological behavior e.g. in that additionally one or more reactive components (e.g. urethane acrylate oligomers, urethane methacrylate oligomers, acrylated or methacrylated polyurethanes, acrylated or methacrylated polyurethane ureas, acrylated or methacrylated polyesters, acrylated or methacrylated polyamides, acrylate- or methacrylate-functional block co-polymers, alkenyl- or alkynyl-functional urethane oligomers, alkenyl- or alkynyl-functional polyurethanes, alkenyl- or alkynyl-functional polyurethane ureas, alkenyl- or alkinyl-functional polyesters, alkenyl- or alkinyl-functional polyamides, alkenyl- or alkinyl-functional block co-polymers, thiol-functional urethane oligomers, thiol-functional polyurethanes, thiol-functional polyurethane ureas, thiol-functional polyesters, thiol-functional polyamides, thiol-functional block co-polymers) in the photocurable starting material components and/or by further addition of one or more non-reactive additives (e.g. but not limited to one or more thixotropes and/or rheology modifiers) to the starting material. The selection of one or more reactive components and their amounts for the addition to a photocurable starting material component in order to provide the starting material with non-Newtonian rheological behavior can in principle be selected freely, in order to obtain certain rheological properties of the starting material.

The starting material can e.g. have a viscosity or a constant shear viscosity which is for example less than 30,000 mPas, less than 20,000 mPas, less than 10,000 mPas, less than 5000 mPas, or less than 1000 mPas. (The constant shear viscosity relates to the plateau value of the viscosity which is achieved in the case of unidirectional constant shearing, e.g. the value of the viscosity after the breaking of the thixotropic network. Preferred constant shear viscosities are less than 30,000 mPas, more preferably less than 10,000 mPas, and most preferably less than 1000 mPas. The viscosity in the case of constant shearing can be measured at ambient temperature (e.g. room temperature) printing temperature, or a different temperature (e.g. increased or reduced). The measurement at printing temperature can be advantageous when determining the suitability of a starting material for printing.

The constant shear viscosity can be measured e.g. under continuous shearing at constant speed, e.g. at shearing speeds of approximately 0.00001 s⁻¹ to approximately 1000 s⁻¹).

As mentioned, the starting material can contain at least one additive. Examples for additives are, as mentioned, a filler, a thixotrope or a rheology modifier, a defoamer, a stabilizer, an oxygen scavenger, a non-reactive solvent or diluent, and a dye. In the case of each additive, it may be a single additive or a mixture of a plurality of additives. A thixotrope can thus contain e.g. a single thixotrope or a mixture of two or more thixotropes.

The additives can preferably be selected such that they do not react in an undesired manner with other components or additives which are or may be contained in the starting material.

As mentioned, an additive may be a filler or comprise at least one such. A filler can be contained in an amount of more than 0 to less than 90 wt. %, wherein the amount is typically determined by the purpose of the filler and the desired end use properties for the object to be produced. Advantageously, the fillers can be selected such that the optical properties, in particular the transparency or transmission, of the starting material is retained, e.g. in that the particle size of the filler is selected such that it is substantially smaller than the excitation wavelengths, or in that the refractive indices of the filler and of the starting material acting as a matrix are matched to one another, in order to prevent or at least to reduce undesired scattering effects. Fillers can in particular be used in order to modify one or more properties of the starting material or the object, e.g. with respect to rigidity, strength, viscosity, impact strength, creep strength, fatigue strength, mechanical return, mechanical loss tangent, glass transition temperature, thermal decomposition temperature, thermal conductivity, thermal resistance, moisture absorption, electrical conductivity, static dissipation, dielectric constant and loss tangent, density, refractive index, optical dispersion, opacity to ionizing radiation, and resistance to ionizing radiation. Fillers can, as indicated, also be used in order to change the properties of the starting material or object, e.g. rheological properties such as viscosity and thixotropy, and optical properties such as the refractive index. Examples for fillers are inter alia silicon dioxide, aluminum oxide, zirconium dioxide, silicate glasses such as soda lime glass, boron silicate glass, sodium silicate glass, lead glass, aluminosilicate glass, barium glass, thorium glass, glass ceramics, chalcogenide glasses, glass microspheres and microbubbles; nanoclays such as laponite, montmorillonite, bentonite, kaolinite, hectorite and halloysite; calcium phosphate minerals such as hydroxylapatite, mineral fillers such as chalk, mineral dust, cinder dust, fly ash, hydraulic cement, loess, limestone, kaolin, talc and wollastonite. Examples for particle size ranges are less than 10 micrometers, less than 1 micrometer, 10 nm to 500 nm, 10 nm to 90 nm, 40 nm to 70 nm. Smaller particle sizes, in particular sizes below approximately 100 nm, may be advantageous in order to achieve a high optical transparency or transmission of the starting material and facilitate the printing. Control of the particle size distribution, e.g. monodisperse, bimodal or trimodal size distributions, may be advantageous, in order to control the rheological properties, to increase the weight fraction of the filler, or to influence the properties of the starting material and/or of the object in a desired manner.

In one embodiment, an additive may be a substance which adjusts the refractive index of the liquid or pasty components to the filler. An example for such a substance is polyethylene glycol (PEG) or derivatives thereof, in particular polyethylene glycol diacrylate (PEGDA) or derivatives thereof. Further examples for substances for adjusting the refractive index include halogenated, in particular iodinated, substances. When using a substance of this kind, fillers having a non-adjusted refractive index or fillers having particle sizes of over 50 nm can be used, in particular over 100 nm, more particularly over 500 nm, more particularly over 1 μm, more particularly over 10 μm.

Further examples for additives are thixotropes and rheology modifiers. Suitable thixotropes or rheology modifiers are for example urea derivatives; modified urea compounds such as Rheobyk 410 and Rheobyk-D 410 (available from BYK-Chemie GmbH), pyrogenic metal oxides (also referred to as pyrogenic metal oxides), including but not limited to pyrogenic silicic acid, pyrogenic clay; zirconium dioxide, precipitated metal oxides, including but not limited to precipitated silicic acid, precipitated clay; unmodified and organically modified sheet silicate clays; dimer and trimer fatty acids; polyether phosphates; oxidized polyolefins; hybrid oxidized polyolefins with polyamide; alkali-soluble/swellable emulsions; cellulose ether; hydrophobically modified alkali-soluble emulsions; hydrophobically modified urethane based on ethylene oxide; saccharose benzoate; ester-terminated polyamides; tertiary amide-terminated polyamides; polyalkyleneoxy-terminated polyamides; polyether amides; acryl amidomethyl cellulose ester polymers; polyethylene imine; polyurea; organoclay; hydrogenated castor oil; organic base salts of a clay mineral (e.g. montmorillonite), and other silicate-like materials; aluminum, calcium and zinc salts of fatty acids, such as lauric and stearic acid.

Thermally reversible gelling agents, such as ester-terminated polyamides, tertiary amide-terminated polyamides, polyalkyleneoxy-terminated polyamides, and polyether amides, and combinations thereof, are conceivable for use as thioxtropes. Examples for these are Crystasense LP1, Crystasense LP2, Crystasense LP3, Crystasense MP, Crystasense HP4, Crystasense HP5, Rheoptima X17, Rheoptima X24, Rheoptima X38, Rheoptima X58, Rheoptima X73 and Rheoptima X84 (available from Croda). Crystasense HP-5 is a preferred example of a thixotrope.

Further examples are metal oxides, in particular metal oxides that have been surface-treated, in order to provide particular dispersibility properties which are compatible with the starting material.

A thixotrope can be contained in the starting material in an amount of for example approximately 0.05 wt. % to approximately 15 wt. %, in particular from approximately 0.5 wt. % to approximately 15 wt. %, more particularly from approximately 0.5 wt. % to approximately 10 wt. %, more particularly from approximately 1 to approximately 10 wt. %. In principle, a thixotrope is preferably contained in an amount that is effective for limiting the movement of the three-dimensional object or of one or more regions thereof in the starting material during the production of the object. Preferably, the thixotrope is contained in the starting material, which is effective for limiting the movement of the object which floats in the working volume (without contact with the container surface) during the formation). In this case, the orientation and/or position of the object in the working volume during the production remains (substantially) unchanged.

An example for a defoamer, mentioned further above, which can be used for assisting the elimination of bubbles which occur during the processing and handling, is BYK 1798 (a silicon-based defoamer) (available from BYK-Chemie GmbH).

It is furthermore the case in general that the starting material can contain water. The starting material can thus be an aqueous solution. The fraction of water can be between 5 and 99.9 wt. %, in particular between 30 and 99.9 wt. %, more particularly between 40 and 99.9 wt. %, more particularly between 50 and 99.9 wt. %, more particularly between 60 and 99.9 wt. %, more particularly between 70 and 99.9 wt. %, more particularly between 80 and 99.9 wt. %, more particularly between 90 and 99.9 wt. %. In such embodiments, corresponding additives, such as rheology modifiers, e.g. in the form of polyacrylic acids, gelatines, etc., can be soluble in water or in the water/monomer or water/oligomer mixture, or miscible with water or the water/monomer or water/oligomer mixture. A corresponding solubility of miscibility of the additives in or with water should be ensured in particular in a temperature range between 2° and 40° C., in particular between 25 and 37° C., alternatively between 2° and 30° C., alternatively again between 35 and 40° C.

Corresponding aqueous starting materials, in particular those which contain one or more additives that are soluble in water and/or miscible with water, are in particular selected, in their composition, in such a way that they are transparent. This is in particular to be understood to mean that the starting material, also with additives, in particular in a wavelength range between 370 and 800 nm, in particular between 400 and 800 nm, more particularly between 450 and 800 nm, has a transmission of at least 30%, in particular at least 50%, more particularly at least 80%, more particularly at least 90%, in the region of the irradiated light of the first wavelength and/or in the region of the irradiated light of the second wavelength. In this case, the transmission relates to an optical path length corresponding to the Beer-Lambert law of 10 mm. A corresponding transmission should be ensured in particular in a temperature range between 2° and 40° C., in particular between 25 and 37° C., alternatively between 2° and 30° C., alternatively again between 35 and 40° C.

Corresponding aqueous starting materials, in particular those which contain one or more additives that are soluble in water and/or miscible with water, are in particular selected, in their composition, in such a way that they have a pH in the range between 5 and 10, in particular between 6 and 9, more particularly between 7 and 8, more particularly of 7.4. In this way, an undesired precipitation of additives and/or an undesired emulsion formation can be prevented or at least reduced. The pH can be set or stabilised by adding a buffer, e.g. via a phosphate-buffered salt solution, PBS for short. A corresponding pH should be ensured in particular in a temperature range between 2° and 40° C., in particular between 25 and 37° C., alternatively between 2° and 30° C., alternatively again between 35 and 40° C.

In general it may be advantageous for the printing process if the pH of the starting material is above 8, in particular above 8.5, more particularly above 9. A corresponding pH provides a large printing or process window. Furthermore, a corresponding pH typically has a positive effect on the rheological properties of the starting material and on the optical properties, in particular the transparency, of the starting material.

As a further conceivable additive, the starting material can contain one or more of the following gelling agents, which can also serve as rheology modifiers. A gelling agent can be e.g. a polymer, in particular a polymer comprising carboxylic acids, e.g. polyacrylic acid, or cross-linked polyacrylic acids; or a polyvinyl alcohol or a derivative thereof; or a polysaccharide or a derivative thereof; or a peptide or protein or a derivative thereof, in particular gamma-carrageen; or gelatine or a derivative thereof. The addition of a gelling agent or in general a rheology modifier is preferred when the starting material contains a low-viscosity monomer or oligomer. The addition of a rheology modifier has been found to be particularly advantageous if the starting material contains a polyethylene glycol diacrylate derivative (PEGDA), in particular having a fraction of at least 10 wt. %, in particular at least 20 wt. %, more particularly at least 30 wt. %, more particularly at least 40 wt. %, more particularly at least 50 wt. %, more particularly at least 60 wt. %, more particularly at least 70 wt. %, more particularly at least 80 wt. %, more particularly at least 90 wt. %.

In one embodiment, the light of the first wavelength can be irradiated first in the first layer partial volume and then in the second layer partial volume with a distribution that is substantially homogeneous with respect to at least one of the following light parameters: light intensity and light color. In this way, substantially homogeneous illumination of the respective layer partial volume can be achieved. Alternatively it can be provided that the light of the first wavelength is irradiated first in the first layer partial volume and then in the second layer partial volume with a distribution that is substantially homogeneous with respect to at least one of the following light parameters, wherein the inhomogeneous distribution in the first layer partial volume can be different from the inhomogeneous distribution in the second layer partial volume. For example, for the light of the first wavelength a gradient for the light intensity can be formed over the width and/or the height of the layer partial volume.

The light of the second wavelength can be projected first onto the first layer partial volume and then onto the second layer partial volume, in each case with a distribution that is substantially non-homogeneous with respect to at least one of the following light parameters: light intensity and light color. While the light of the first wavelength can illuminate the respective layer partial volume as spatially homogeneously or uniformly as possible, the light of the second wavelength does not catch the starting material homogeneously in that layer partial volume, but rather in a manner corresponding to the non-homogeneous light distribution of the light projection directed thereto (of the light of the second wavelength), in order to thus correspondingly bring about the optical processing of the non-homogeneous light distribution (light parameter). This allows for the formation or production of a spatial outer contour. Optionally, different non-homogeneous light distributions (different projections) can be irradiated per layer partial volume.

When irradiating the first layer partial volume and/or when irradiating the second layer partial volume with the light of the first wavelength, a layer partial volume having a layer thickness of at most approximately 1 mm can be irradiated or caught. Alternatively, a layer partial volume having a layer thickness of at most approximately 500 μm can be irradiated. In a further alternative embodiment, a layer partial volume having a layer thickness of at most approximately 250 μm can be irradiated. A minimum layer thickness for irradiated layer partial volumes can be approximately 10 μm.

A plurality of optical elements can also be formed (at least in part) from the starting material (by means of the optical processing).

The formation of the at least one optical element can comprise formation of at least one of an optical lens, a lens of imaging quality, an intraocular lens, a lens array, a diffusor, a prism, an optical grating, a diffractive optical element, and an optical waveguide. The intraocular lens can in particular be an accommodating intraocular lens. In particular, formation of a (functional) contact lens can be provided. In other words, according to the method in particular an optical lens, a lens of imaging quality, an intraocular lens, in particular an accommodating intraocular lens, a lens array, a diffusor, a prism, an optical grating, a diffractive optical element, or an optical waveguide, can be produced.

In one embodiment, the optical element can be formed having a transmission of at least 10%, in particular at least 20%, more particularly at least 30%, more particularly at least 40%, more particularly at least 50%, more particularly at least 60%, more particularly at least 70%, more particularly at least 80%, more particularly at least 90%, in a range of 300 nm to 2500 nm, preferably of 380 nm to 2000 nm, more preferably of 400 nm to 1800 nm, most preferably of 450 nm to 1600 nm. In a further embodiment, the optical element can be formed having a surface roughness (rms) of at most 100 nm, preferably at most 50 nm, more preferably at most 30 nm, most preferably at most 10 nm. The transmission relates in particular to a thickness or wall thickness of the optical element or an optical path length corresponding to the Beer-Lambert law of the optical element of 1 mm or 10 mm. The smallest individual structures of the optical element can be of a size of 0.1 μm to 10 μm.

At this point, it should generally be noted that an optical element within the meaning of the application is any element that has a transmission of at least 10%, in particular at least 20%, more particularly at least 30%, more particularly at least 40%, more particularly at least 50%, more particularly at least 60%, more particularly at least 70%, more particularly at least 80%, more particularly at least 90%, in a wavelength range of 300 nm to 2500 nm, preferably of 380 nm to 2000 nm, more preferably of 400 nm to 1800 nm, most preferably of 450 nm to 1600 nm. The transmission typically relates to a thickness or wall thickness of the optical element or an optical path length corresponding to the Beer-Lambert law of the optical element of 1 mm.

The optical element can be configured to shape light. In particular, the optical element can be configured to refract, diffract, reflect, scatter, interfere and/or polarize light. The optical element can be configured as at least one of a spherical lens, an aspherical lens, a freeform lens, a Fresnel lens, a lens array, a diffusor, a prism, an optical grating, a diffractive optical element, and an optical waveguide.

The further processing of the green body can be free of photochemical post-curing and/or tempering and/or further process steps such as grinding, polishing and/or coating, in particular for forming the optical element having lower surface roughness.

At least one functional element can be provided in the starting material, in particular before and/or during the optical processing. Furthermore, the optical element can be formed at least in part adjacently to the at least one functional element. In particular, the optical element can be formed around the at least one functional element, preferably such that the formed optical element surrounds the at least one functional element at least in part (in particular completely).

The at least one functional element can be arranged at least in part, in particular completely, in the starting material and/or at least in part adjacently to the starting material. It can be provided to arrange the at least one functional element in the starting material by means of an arranging device.

The at least one functional element comprises at least one of the following elements: an actuator element, a sensor element, an energy source element (for providing electrical energy, for example a solar cell), a display, a lens holder (lens mount), and a prefabricated further optical element. In addition or alternatively, the at least one functional element can comprise at least one optical component, in particular at least one of one or more apertures and optical filters.

The at least one prefabricated further optical element can be a lens, a lens array, an optical grating, a diffractive optical element, or an optical waveguide. The optical element can in particular be formed bound to a glass fiber and/or a light source.

The at least one functional element can comprise an optoelectronic component, in particular at least one of a light source (for example an LED chip or a laser diode) and an optical sensor (for example CMOS or CCD chip).

The at least one functional element can comprise at least one electronic component, in particular at least one of an electronic circuit, a resistive sensor, an electronic chip, a battery, an electrical lead, and an electrical terminal.

The at least one functional element can comprise at least one component which is provided with terminals at the surface, such that it is preferably possible to control a further electronic functional element in the interior of the component. The at least one functional element can comprise at least one micropump or a mechanical actuator.

The at least one functional element can have a refractive index that is the same as or similar to the starting material, in particular such that no refraction of the light of the first and/or second wavelength occurs at the interface between the functional element and the starting material. The at least one functional element can have a (functional element) refractive index (and/or be formed having a (functional element) refractive index) that deviates (relatively) from a starting material refractive index by at most 3%, preferably at most 1%, particularly preferably at most 0.3%, particularly preferably at most 0.1%.

The at least one functional element may be non-reflective.

The method can further comprise finalizing the (at least partially) formed optical element. The method can include laser machining and/or mechanical machining of the optical element. The laser machining and/or the mechanical machining of the optical element are conceivable examples for a finalization of the (at least partially) formed optical element.

During optical processing, the starting material can be irradiated around the at least one functional element with light of the first wavelength and light of the second wavelength, from at least two sides, in particular two different sides, more particularly from four different sides. The irradiation from at least two sides in particular two sides, more particularly four sides, can take place simultaneously or in succession. For example, the optical processing of the functional element can take place in a first direction and (simultaneously or successively) in a second direction that is different from the first direction. In particular, the functional element can be rotated relative to the light source/light sources between optical processing in the first direction and optical processing in the second direction.

The irradiation can take place by means of light sources (of the first wavelength and/or second wavelength) that are arranged opposite one another, in particular such that the starting material is arranged between the opposing light sources.

The irradiation with light of the first wavelength and/or light of the second wavelength can take place using a plurality of light sources, such that the light is preferably irradiated into layer partial volumes which are superimposed at least in part. The at least one functional element can be arranged in the starting volume in such a way that does not impede the beam path of the light of the first and second wavelength, or impedes it as little as possible. In particular, a plurality of light sources can be used for providing the light of the first and/or second wavelength, in order to reach all the partial volumes around the functional element.

Alternatively, the light of one light source can be irradiated into the starting volume via the arrangement of light reflection elements, in particular mirrors, such that all the partial volumes around the functional element can be irradiated. Optionally, non-adjacent layer partial volumes can be irradiated in succession, wherein in particular first one part of the starting volume is processed in one direction, and subsequently a further part of the starting volume is processed in a direction different therefrom, preferably the opposite direction. In cases in which not all the partial volumes around the functional element can be irradiated, the described options can be used for minimizing the partial volumes that cannot be reached.

In particular, the light of the first wavelength can be radiated into the starting material by means of a mirror ring, wherein the starting material is arranged inside the mirror ring and/or along the axis of rotation of the mirror ring. In this way, a circular light section for the light of the first wavelength can be formed. The light of the second wavelength can be radiated into the starting material orthogonally to the light section.

In one embodiment, both a light section of the first wavelength and also the projector image of the second wavelength can be created by means of a (single or integrated) projection device and then irradiated onto/into the receiving vessel. In this case, an arrangement of light reflection elements, in particular mirrors, can be provided, in order to bring about a separation of the light section from a beam axis of the projection device and the irradiation of the light section transversely to the projection image the receiving vessel.

In one embodiment, the receiving vessel can be moved, in order to move the light section through the working volume. The projector image can be imaged sharply within the light section by means of variable focus optics. In one embodiment, the movement direction can be changed during the method, such that parts of the working volume are caused to cure in different directions. In a further embodiment, the receiving vessel remains immobile, and the light section is moved, for example in that a display element of the projection device, for example an LC or a DM display, is divided into a central region, which generates the projector image, and into two regions mounted laterally thereof, which create the light section. For this purpose, pixels of the display element can be actuated by means of actuating the optical transmission and/or reflection of the display element in such a way as to achieve a lateral shift of the light section. In this case, a central region of the display element can be irradiated with the first wavelength, and outer regions of the display element can be irradiated with the second wavelength.

It can be provided to irradiate light (at least) of a third wavelength onto the material to be processed, wherein the third wavelength is different from the first and the second wavelength. In this case, the light of the third wavelength can for example be irradiated onto a layer partial volume currently being processed, at the same time as or temporally offset from the irradiation of the light of the second/first wavelength. For this purpose, the projection device or a further projection device can be used, in order to selectively limit the light irradiation onto the current layer partial volume. As a result, chemical/physical processes for material treatment initiated or occurring in the working volume of the material to be processed can be (additionally) influenced, for example when using polychromic multiphoton polymerization.

Embodiments of the method, given by way of example, will be explained in the following:

In one embodiment, the starting material can, in particular after being filled into a container defining the working volume, be stirred for a given time, in particular of at least one hour, in particular at least six hours, more particularly at least twelve hours, more particularly at least eighteen hours, more particularly at least twenty hours. Corresponding stirring of the starting material can, as mentioned above, lead to desired rheological properties of the starting material, i.e. in particular a desired yield strength, being set.

In one embodiment, the starting material can undergo at least one process for removing impurities, in particular particulate impurities, before the irradiation, in particular before being filled into a container defining the working volume, wherein the process in particular comprises filtering the starting material by means of a filter device. Thus any impurities which have a negative effect on the optical properties of the optical element to be produced can be removed, which has a correspondingly positive effect on the quality of the optical element to be produced.

In a further embodiment, the further processing of the green body, such that an optical element is formed at least in part, in particular completely, from the green body, in particular the post-curing of the green body, can be carried out under a protective gas atmosphere, in particular an argon, carbon dioxide or nitrogen atmosphere. It was surprisingly found that further processing of the green body, in particular the post-curing of the green body, more particularly the photochemical and/or thermally post-curing of the green body, under a corresponding protective gas atmosphere leads to better component surfaces. Specifically, in this way e.g. undesired sticky component surfaces can be avoided or at least reduced.

In a further embodiment, the further processing of the green body can comprise photochemical post-curing of the green body by means of at least one additional photoinitiator, wherein the additional photoinitiator is configured to perform a photochemical reaction, in a wavelength different from the first and the second wavelength, that brings about photochemical post-curing of the green body. Therefore, photochemical post-curing of the green body can advantageously be carried out using an additional photoinitiator, which has no or the least possible absorption at the first and second wavelength, such that it is ensured that the additional photoinitiator does not or barely reacts in the case of irradiation of the starting material with the light of the first and second wavelength.

An example for a corresponding additional photoinitiator is an alpha diketone, in particular camphorquinone, or a corresponding additional photoinitiator can contain at least one alpha diketone, in particular camphorquinone. Corresponding additional photoinitiators have proven to be particularly expedient if the first wavelength is less than 400 nm, in particular 375 nm, and the second wavelength is 500 nm or over 500 nm.

In general, an additional photoinitiator can be used, which has an absorption maximum between the first and the second wavelength. An example for a corresponding additional photoinitiator is an alpha diketone, in particular camphorquinone, the absorption maximum of which is approximately 470 nm. In one embodiment of the method, in which the first wavelength is below 420 nm and the second wavelength is above 500 nm, the absorption maximum of camphorquinone is thus therebetween.

In general, an additional photoinitiator can be used, which has an absorption in the wavelength range between 400 and 600 nm. As mentioned, the absorption maximum of the additional photoinitiator can be between the first and the second wavelength. In general, an additional photoinitiator can be used, which changes its optical properties, i.e. in particular bleaches, in the case of irradiation with light of a wavelength that is between the first and second wavelength.

In general, an additional photoinitiator can be used, which has an extinction coefficient of less than 10,000 l/mol/cm, in particular less than 5000 l/mol/cm, more particularly 1000 l/mol/cm, more particularly less than 500 l/mol/cm, more particularly less than 300 l/mol/cm, more particularly less than 100 l/mol/cm, more particularly less than 50 l/mol/cm, more particularly less than 10 l/mol/cm, more particularly less than 1 l/mol/cm, at the first and/or second wavelength.

An additional photoinitiator can be: an alpha diketone, such as diacetyl, 3,4-hexanedione.

Alternatively or additionally, an additional photoinitiator can be: an aromatic alpha diketone, such as benzil or a benzil derivative, or acenaphthoquinone.

Alternatively or additionally, an additional photoinitiator can be: a cyclic alpha diketone, such as camphorquinone or 1,2-cyclohexanedione.

Alternatively or additionally, an additional photoinitiator can be: an aliphatic alpha diketone, such as camphorquinone, diacetyl or 3,4-hexanedione.

In general, an additional photoinitiator can be contained e.g. in a specific concentration of 0.0001 to 10 wt. %, in particular between 0.01 and 2 wt. %, more particularly between 0.1 and 2 wt. %, more particularly between 0.1 and 1 wt. %.

The use of an additional photoinitiator which can be irradiated with visible light, in particular light in a wavelength range between 400 and 600 nm, preferably between 420 and 500 nm, is advantageous. Since the additional photoinitiator, as mentioned, can in particular be excited between the first and the second wavelength and barely exhibits any absorption at the first and the second wavelength, it does not or barely impairs the absorption of the starting material at the first and second wavelength, and a large penetration depth for the first and second wavelength during the formation of the object or green body results, such that an installation volume that is as large as possible results, and undesired secondary reactions with the first or second wavelength are prevented or at least reduced. In addition, a homogeneous post-curing of the object can be achieved even in the working volume. In this way, e.g. cracks in the surface of the object can be prevented or at least reduced; this is not the case if the additional photoinitiator is irradiated with light of a wavelength below the first wavelength.

In one embodiment, the post-processing, in particular post-curing, of the object, in particular in the case of use of a corresponding additional photoinitiator, can include irradiating the object with light of a wavelength that is between the first and second wavelength. In this way, as mentioned, e.g. cracks in the surface of the object can be prevented or at least reduced; this is not the case if the additional photoinitiator is irradiated with light of a wavelength below the first wavelength. This can optionally constitute an independent aspect of the invention.

In one embodiment, the green body can be irradiated with light of a wavelength that is between the first and second wavelength, wherein the absorption reduces at at least a wavelength that is between the first and second wavelength. In this way, the penetration depth for the light used for post-processing can be increased during the irradiation, as a result of which in particular the inner part of the green body can be efficiently post-processed, such that a homogeneously cured optical element results. This can optionally constitute an independent aspect of the invention.

In one embodiment, the green body can be irradiated with light of a wavelength that is between the first and second wavelength, wherein the absorption reduces in the wavelength range between the first and second wavelength. In this way, the penetration depth for the light used for post-processing can be increased during the irradiation, as a result of which in particular the inner part of the green body can be efficiently post-processed, such that a homogeneously cured optical element results. This can optionally constitute an independent aspect of the invention.

In one embodiment, the green body can be irradiated with light of a wavelength that is between the first and second wavelength, wherein the absorption reduces at the irradiation wavelength, which is between the first and second wavelength. In this way, the penetration depth for the light used for post-processing can be increased during the irradiation, as a result of which in particular the inner part of the green body can be efficiently post-processed, such that a homogeneously cured optical element results. This can optionally constitute an independent aspect of the invention.

In a further embodiment, the further processing of the green body can include treating the green body with a solvent and/or a monomer, in particular for washing the green body, wherein a solvent and/or a monomer having a molar mass of greater than or equal to 200 g/mol is used. Using a solvent or monomer having a correspondingly high molar mass makes it possible to prevent the solvent or monomer penetrating into the green body, as a result of which its properties may be impaired.

A specific example for a corresponding solvent or monomer is tripropylene glycol monomethyl ether having a corresponding molar mass.

In a further embodiment, the further processing of the green body can include treating the green body with a solvent and/or a monomer, in particular for washing the green body, wherein a highly volatile solvent and/or a highly volatile monomer is used. The use of a highly volatile solvent or monomer makes it possible for drying processes of the green body to be accelerated and the method to thus be made even more efficient.

A specific example for a corresponding low-molecular solvent or monomer is an alcohol, such as ethanol or isopropanol.

In a further embodiment, a starting material can be used that is free of inorganic and/or organic particles. In particular, a starting material can be used that is free of inorganic and/or organic particles of a diameter of greater than 50 μm can be used. This can also have a positive effect on the quality of the optical element to be produced according to the method, in particular because no impairments by inorganic and/or organic particles or nanoparticles are possible. The starting material can nonetheless contain inorganic and/or organic nanoparticles, i.e. in particular particles of a diameter of less than 50 nm, for example in order to set a desired refractive index. Corresponding nanoparticles can be present e.g. in a concentration of between 0.1 and 5 wt. %, in particular between 0.3 and 2 wt. %, more particularly between 0.5 and 1.5 wt. %. Corresponding nanoparticles can be e.g. SiO₂, ZrO₂ and TiO₂ nanoparticles.

In a further embodiment, a starting material can be used that contains exclusively organic components. This can also have a positive effect on the quality of the optical element to be produced according to the method, in particular because no impairments by inorganic components are possible.

In a further embodiment, a starting material can be used that is free of organic polymers. This can also have a positive effect on the quality of the optical element to be produced according to the method, in particular because no impairments by organic polymers are possible, which may possibly lead to undesired polymerization-related phase separations.

In a further embodiment, the optical element to be produced can have a main extension plane having a planar geometric shape. This applies e.g. for optical lenses. In such embodiments, the construction or printing direction of the optical element is expediently selected so as to be at an angle, in particular a right angle, to the main extension plane. In this way a sinking of the green body in the starting material, which may have a negative effect on the quality of the optical element to be produced, can be prevented or at least slowed.

It is in principle conceivable for all embodiments for the construction or printing direction to be selected from top to bottom, or vice versa. The construction or printing direction can thus be oriented along a vertical axis.

In a further embodiment, the first wavelength may be less than or equal to 400 nm, in particular less than or equal to 375 nm. Alternatively or in addition, the second wavelength can be 405 nm.

In a further embodiment, the starting material and/or the photoinitiator and/or a co-initiator can be free of amine bonds or can comprise less than 10 wt. %, in particular less than 5 wt. %, more particularly less than 4 wt. %, more particularly less than 3 wt. %, more particularly less than 2 wt. %, more particularly less than 1 wt. %, more particularly less than 0.5 wt. %, more particularly less than 0.25 wt. %, more particularly less than 0.1 wt. % of one or more amine bonds. This can also have a positive effect on the quality of the optical element to be produced according to the method, in particular because undesired interactions of corresponding amine bonds with the starting material can be prevented, which may have a negative effect on the component quality of the optical element to be produced. In particular, in this way undesired coloring or discoloration, in particular undesired yellowing, of the optical element to be produced can be prevented or at least reduced.

In a further embodiment, at least one first irradiation device can be used, which is configured such that it irradiates light of the first wavelength into the working volume in order to create at least one first light projection in the working volume, wherein the at least one first light projection comprises a plurality of light beams which pass through the working volume in at least one light plane. Furthermore, at least one light modulation device can be used, which is associated with the at least one first irradiation device, wherein the at least one light modulation device is configured such that it modulates the spatial extension direction of two or more light beams of the plurality of beams in the at least one light plane in such a way that the two or more light beams extend in a non-parallel arrangement relative to one another.

The at least one light modulation device is configured such that it modulates the spatial extension direction of two or more light beams of the plurality of beams in the at least one light plane in such a way that the two or more light beams extend in a non-parallel arrangement relative to one another. The at least one light modulation device can be configured such that it actively and/or passively changes the spatial extension direction and/or orientation of two or more light beams of the plurality of light beams in the at least one light plane in such a way that at least two of the plurality of light beams extend in a non-parallel arrangement relative to one another. The non-parallel arrangement of the at least two light beams in the at least one light plane typically leads to the at least two light beams intersecting at at least one intersection point within the at least one light plane. In particular, a plurality of intersection points, at which at least two light beams intersect, are created at different positions in the at least one light plane. In contrast to the light planes of conventional volumetric 3D printing devices which have a (substantially) parallel arrangement of (collimated) light beams without intersecting light beams, the at least one light modulation device of the device described here allows for purposeful changing of the spatial extension direction and/or orientation of at least two light beams within the at least one light plane, such that the at least two light beams extend in a non-parallel arrangement, the at least one light modulation device of the device described here allows for purposeful changing of the spatial extension direction and/or orientation of at least two light beams within the at least one light plane, such that the at least two light beams extend in a non-parallel arrangement relative to one another within the at least one light plane, which leads to one or more intersection points being created within the at least one light plane, at which points two or more light beams intersect.

In particular, the at least one light modulation device can be configured to influence the optical coherence of light beams within the at least one light plane, in particular to reduce it at least in part, in that the spatial extension direction and/or the orientation of at least two light beams is purposely changed in such a way that at least two light beams extend in a non-parallel arrangement relative to one another, which results in two or more light beams intersecting at one or more intersection points within the at least one light plane. A change in the spatial extension direction and/or orientation of at least two light beams, such that at least two light beams extend not in parallel with one another in the at least one light plane, also leads to the at least one light plane comprising light beams having angled spatial extension directions, while they cross, pass through or propagate in the working volume. In particular, at least two light beams can cross, pass through or propagate in the working volume at an angle relative to one another that is different from 0°. An intersection point of at least two light beams at one or more intersection points within the at least one light plane can also consist in at least two light beams being able to be superimposed at the one or more intersection points.

The at least one light modulation device can thus be configured to deflect two or more light beams within the at least one light plane, e.g. by diffraction and/or refraction and/or scattering, such that the at least one light plane comprises non-parallel and/or non-coherent light beams. The steering of light beams can include changing the spatial extension direction of one or more light beams, in particular with respect to an original spatial extension direction, such that the at least one light plane comprises non-parallel and/or non-coherent light beams. This is precisely the opposite operating principle from that of conventional light sheet generators, which are configured for creating light sheets from non-intersecting collimated light beams, i.e. light beams having a parallel spatial extension direction without intersections. As a result, in contrast with conventional light sheets or light sections, which substantially have a rectangular basic shape which is defined vertically by a parallel arrangement of topmost and bottom most light beams, the at least one light section, which is modified by the at least one light modulation device, can have a non-rectangular basic shape, e.g. a trapeze shape, within the working volume, which shape is defined vertically by non-parallel light beams.

In particular, the at least one light modulation device can be configured such that it generates modified light beams having different properties from a Gaussian beam. Thus, the at least one light modulation device can be configured such that it generates modified light beams which for example have a non-Gaussian beam profile. For example, the at least one light modulation device can be configured such that it generates modified light beams, specifically for example Airy beams or Bessel beams, or light beams having a characteristic that for example resembles Airy beams or Bessel beams.

Experiments have surprisingly shown that the purposeful creation of respective intersection points, at which two or more light beams intersect in at least one light plane, respective undesired artefacts, and thus undesired properties, such as (quasi) regular or irregular streaking artefacts or sliding artefacts, can be significantly reduced, which leads to an optical appearance of the produced green body as though it were constructed by layers, as is the case for example in conventional additive manufacturing according to principles of stereolithography and/or principles of digital light processing and/or volumetric printing methods, e.g. computed axial lithography (CAL). The at least one light modulation device thus has a positive effect on the properties of the three-dimensional objects produced using the device.

The at least one light modulation device can comprise one or more optical elements, wherein each optical element is configured such that it changes the original spatial extension direction of the incident light beam, in order to create a light beam that has a different spatial extension direction relative to the original spatial extension direction. The optical elements can be configured as or comprise e.g. optical lenses, in particular microlenses, and/or optical diffusor elements, in particular elliptical diffusor elements.

The light modulation device can be mounted so as to be movable, in particular relative to the working volume, in at least one translational and/or rotational degree of freedom of movement. In particular, the light modulation device can be mounted so as to be movable in at least one spatial direction, in a uniform or oscillating movement. For this purpose, a corresponding drive coupled to the light modulation device, can be present, in particular in addition to an associated controller.

In principle, reflective and/or diffractive optical elements are possible. It is conceivable that at least one optical element of the at least one light modulation device comprises e.g. a combination of at least two of: one or more respectively optically permeable surfaces, one or more respectively optically reflective surfaces, and/or one or more respectively optically diffractive surfaces, a combination of at least two of optically permeable surfaces, optically reflective surfaces and/or optically diffractive surfaces. Corresponding optically permeable surfaces and/or optically reflective surfaces and/or optically diffractive surfaces can for example be formed of or comprise one or more optically permeable coatings and/or reflective coatings and/or optically diffractive coatings.

In a further embodiment, at least one measure for changing the optical properties of the green body can be carried out. In this way, it is possible to ensure that the green body has the desired optical properties, i.e. in particular a desired transmission.

The at least one measure can preferably include changing the optical properties of the green body, which leads to a reduction in the absorption properties of the green body or the optical element for at least a wavelength in a wavelength range between 300 nm and 2000 nm, in particular between 350 nm and 900 nm, and/or to an increase in the light permeability properties of the green body or the optical element for at least a wavelength in the wavelength range between 300 nm and 2000 nm, in particular in the wavelength range between 350 nm and 900 nm, in particular in the wavelength range between 400 nm and 800 nm.

The at least one measure for carrying out at least one measure for modifying the optical properties of the green body can include modifying the optical properties of the green body, which results in an average transmission or an integral of the transmission between 300 nm and 2000 nm, in particular between 350 nm and 900 nm, in particular between 400 nm and 800 nm, being reduced by at least 1%, in particular at least 2%, in particular at least 3%, in particular at least 4%, in particular at least 5%, in particular at least 7.5%, in particular at least 10%, in particular at least 15%, in particular at least 20%, in particular at least 25%, in particular at least 30%, in particular at least 35%, in particular at least 40%, in particular at least 45%, in particular at least 50%, in particular compared with a state of the green body before it has undergone the at least one measure. Alternatively or in addition, the at least one measure for carrying out at least one measure for changing the optical properties of the green body can include changing the optical properties of the green body, which results in an average absorption or an integral of the absorption between 300 nm and 2000 nm, in particular between 350 nm and 900 nm, in particular between 400 nm and 800 nm, being reduced by at least 1%, in particular at least 2%, in particular at least 3%, in particular at least 4%, in particular at least 5%, in particular at least 7.5%, in particular at least 10%, in particular at least 15%, in particular at least 20%, in particular at least 25%, in particular at least 30%, in particular at least 35%, in particular at least 40%, in particular at least 45%, in particular at least 50%, in particular compared with a state of the green body before it has undergone the at least one measure.

Therefore, an optical element can in general be understood to be any element that has an average or integrated absorption per mm thickness of the element for each wavelength in the wavelength range between 300 nm and 2000 nm, in particular between 400 nm and 900 nm, more particularly between 500 nm and 850 nm, more particularly between 600 nm and 800 nm, more particularly between 650 nm and 750 nm, of less than 0.5, in particular of less than 0.3, in particular of less than 0.2, in particular of less than 0.1.

The at least one measure can include changing the optical property of the green body, which leads to an average or integrated absorption per mm thickness of the green body of less than 0.5, in particular of less than 0.3, more particularly of less than 0.2, more particularly of less than 0.1, in a wavelength range between 300 nm and 2000 nm, in particular 350 nm and 900 nm, more particularly between 400 nm and 800 nm. In particular, the average or integrated absorption per mm thickness of the green body can be less than 0.5, in particular less than 0.3, in particular less than 0.2, in particular less than 0.1, for each wavelength in the wavelength range between 300 nm and 2000 nm, in particular 350 nm and 900 nm, in particular between 400 nm and 800 nm.

In particular, the average or integrated absorption per mm thickness of the optical element can be less than 0.5, in particular less than 0.3, in particular less than 0.2, in particular less than 0.1, for each wavelength in the wavelength range between 300 nm and 2000 nm, in particular 350 nm and 900 nm, in particular between 400 nm and 800 nm.

The at least one measure can include e.g. thermal treatment of the green body and/or optical treatment of the green body, in particular by irradiating the green body using electromagnetic radiation, and/or chemical treatment of the green body.

The thermal treatment can include aging of the green body at a temperature between 5° and 150° C., in particular between 75 and 125° C., in particular for a duration of between 1 and 24 h min, more particularly between 1 and 20 h, more particularly between 1 and 16 h, more particularly between 1 and 12 h, more particularly between 1 and 8 h, more particularly between 1 and 4 h, more particularly between 1 and 30 min.

The optical treatment can include irradiating the green body with electromagnetic radiation of a wavelength of between 350 nm and 1000 nm, in particular between 400 nm and 800 nm, more particularly between 350 nm and 500 nm or between 420 nm and 800 nm, in particular for a duration between 0.5 and 180 min, between 5 and 60 min.

The optical treatment of the green body can take place in the working volume or after removal of the green body from the working volume.

The three-dimensional object can undergo tempering after optical treatment, wherein the temperature-control can in particular include heating the green body to a temperature in the range between 50° C. and 150° C. for a time in the range between 1 min and 60 min, in particular 5 min and 30 min.

The chemical treatment can include e.g. the chemical change, in particular by oxidation and/or reduction, of the chromophore molecules, in particular the remaining photoinitiator molecules, of the green body, wherein the molecules have a (visible) color in the visible wavelength spectrum of between 380 nm and 750 nanometers, using at least one chemical modification agent, e.g. an oxidation or reduction agent.

Specifically, the at least one chemical modification agent can be or comprise a chlorine-based substance, in particular chlorine, hypochlorite, chlorine dioxide, or an oxygen-based substance, in particular ozone, oxygen, peroxide, perborate, percarbonate, peracetic acid, or chlorine or a chlorine compound.

The at least one chemical modification agent can be added to the photopolymerized material after the formation of the green body, in that the three-dimensional object is placed in a solution, in particular an organic solution, for a specific time, which solution contains the at least one chemical modification agent, wherein the at least one chemical modification agent migrates out of the solution into the three-dimensional object and possibly remaining co-initiator and/or photoinitiator migrates out of the three-dimensional object into the solution.

The at least one chemical modification agent can be configured in such a way that it changes the chromophore properties of the original chromophore molecules, in particular of the remaining photoinitiator molecules, of the photopolymerizable material (starting material) and/or of the chromophore of the green body resulting from the photopolymerization process, or the at least one chemical modification agent is configured in such a way that it generates a reactive agent which is configured such that it changes the chromophore properties of the chromophore molecules, in particular the remaining photoinitiator molecules, of the green body under the influence of electromagnetic energy, in particular thermal energy and/or radiation energy.

It is the case for all the embodiments that the optical processing of the starting material can also take place using at least one combined light section. A corresponding combined light section can be created e.g. as follows: a first light section is created, which extends along an extension axis through the starting material, and a second light section is created, in which the first light section emerging from the starting material is reflected by at least one reflection element, and the reflected light section thus created extends (substantially) along the extension axis of the first light section, again through the starting material. In principle, every light section described herein can be a corresponding combined light section. It is likewise conceivable for a plurality of combined light sections to be used, which extend through the working volume from at least two, in particular at least three, more particularly at least four, different sides. The extension axes of the respective combined light sections can be oriented at any desired angle relative to one another, i.e. e.g. at an angle of approximately 90°.

A corresponding reflection element can e.g. be or comprise: at least one flat mirror, at least one mirror that is curved once or multiple times, e.g. a doubly concave mirror, at least one plan-convex cylinder lens, at least one piano-concave cylinder lens, etc. Combinations of at least two of the same or different of the above-mentioned reflection elements are conceivable.

### DESCRIPTION OF EMBODIMENTS

Further embodiments will be explained in more detail in the following, with reference to the figures of a drawing, in which:

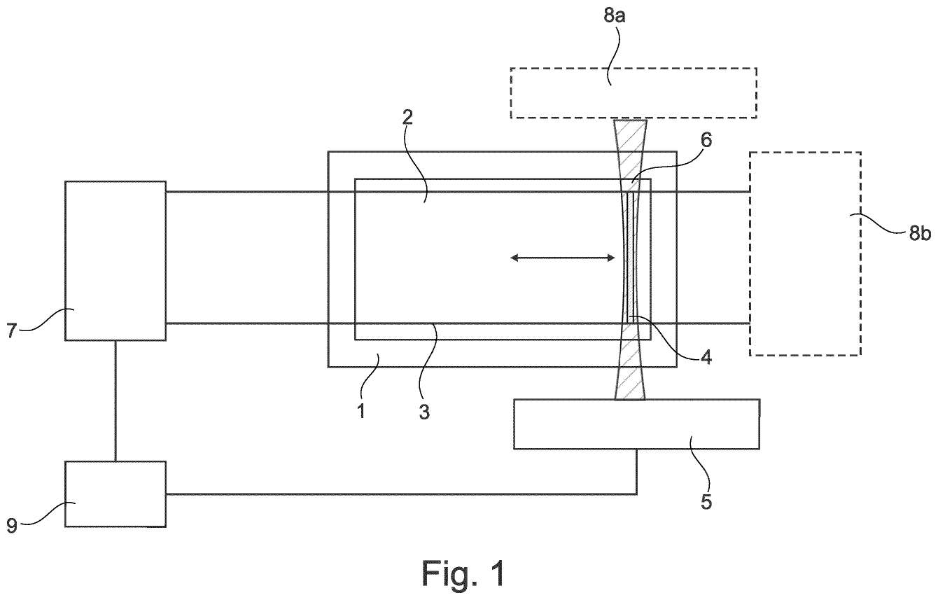

FIG. 1 is a schematic view from above of a device for processing an optically reactive material;

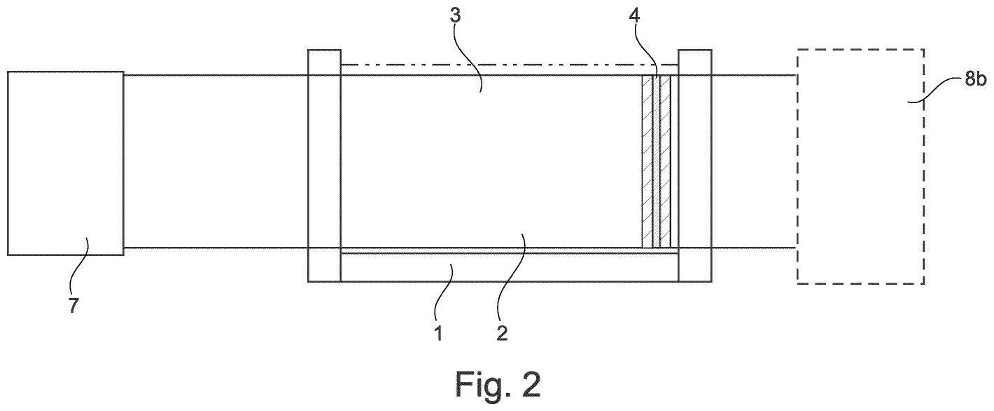

FIG. 2 is a schematic view of the device from FIG. 1 from the side;

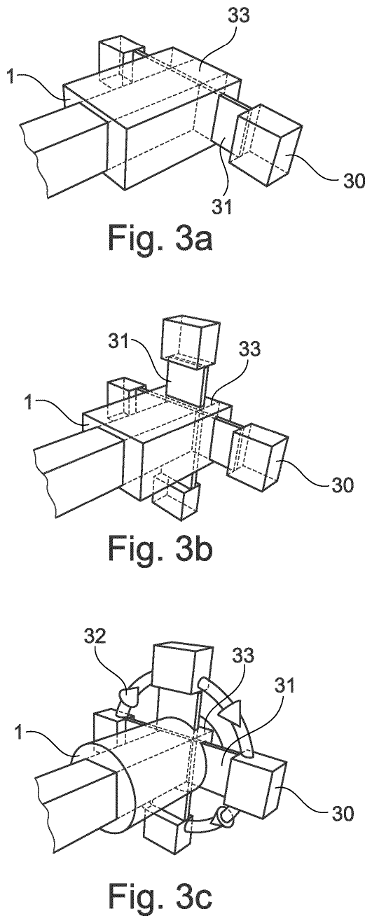

FIG. 3a to 3c are schematic views of an arrangement for optical processing of a starting material in a receiving vessel;

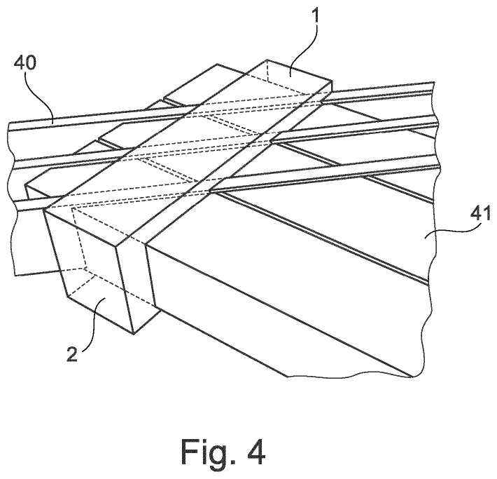

FIG. 4 is a schematic view of a further arrangement for optical processing of a starting material in a receiving vessel;

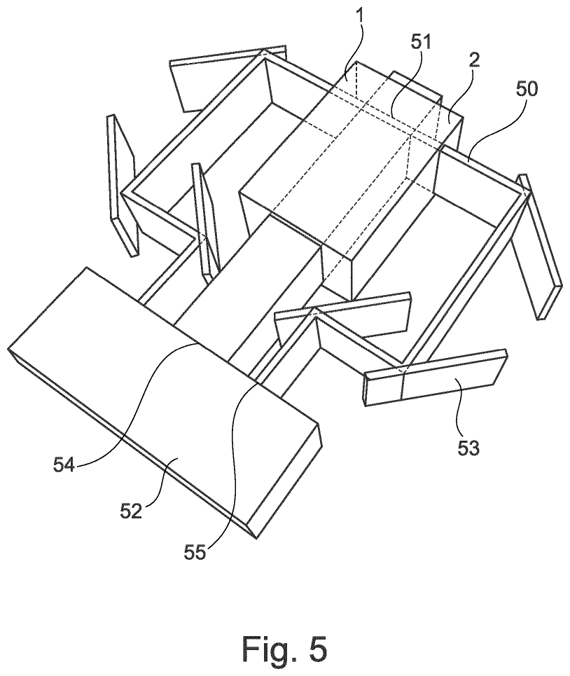

FIG. 5 is a schematic view of another arrangement for optical processing of a starting material in a receiving vessel using a projection device;

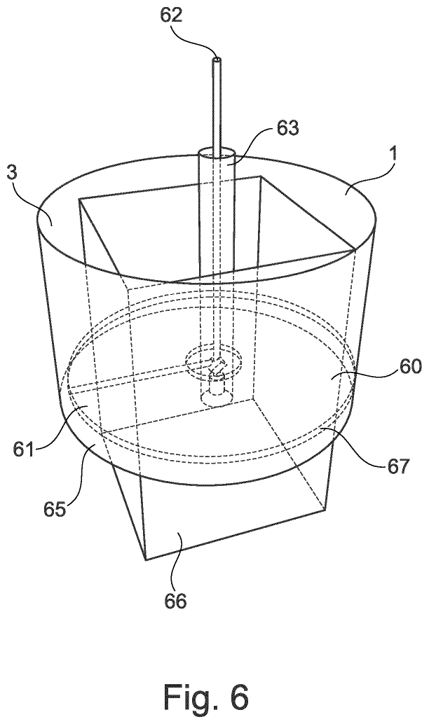

FIG. 6 is a schematic view of a further arrangement for optical processing of a starting material in a receiving vessel;

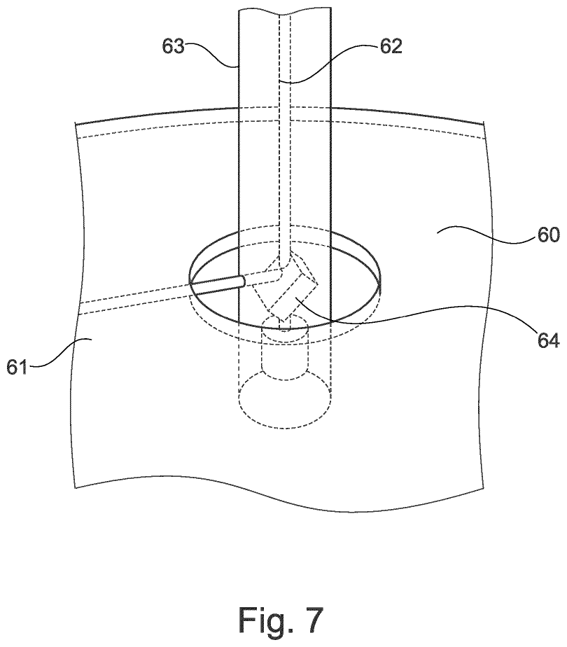

FIG. 7 is a schematic partial view of the arrangement from FIG. 6;

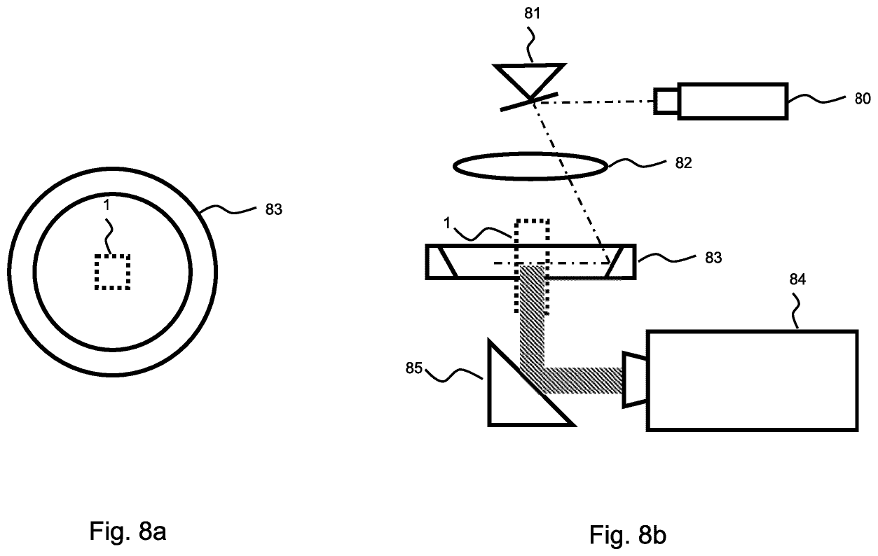

FIG. 8a is a schematic plan view of a further arrangement for optical processing of a starting material in a receiving vessel using a mirror ring; and

FIG. 8b is a schematic side view of a further arrangement.

FIGS. 1 and 2 are schematic views from above and from the side of a device for optical processing of an optically reactive material. A working volume 2 is provided in a receiving vessel 1, which volume is filled at least in part by a starting material 3. The starting material 3 can comprise one or more substances, which can be solid, liquid or pasty. For processing, the starting material 3 is irradiated with light of a first wavelength and light of a second wavelength which are irradiated in the working volume 2 in an overlapping manner for triggering an optically activated reaction in a layer partial volume 4.

The light of the first wavelength is provided with the aid of a first light source 5, which, in the embodiment shown, is configured by way of example as a light section generator. During processing of the starting material 3, an irradiation region 6 for the light of the first wavelength (light section), which, in the embodiment shown, is tapered, is moved piece-by-piece over the working volume 2, such that a layer-wise processing of the starting material 3 takes place. Thus, layer partial volumes of the working volume 2 previously filled with the starting material 3 (layer-form partial volume of the working volume 2) are irradiated in succession, in particular non-overlapping layer partial volumes.

Depending on the current position of the irradiation region 6 (light section), the light of the second wavelength is projected, with the aid of a projector 7, into the layer partial volume currently irradiated with the light of the first wavelength (projector or projection image). This means that the projection plane or the projection volume of the projector 7 are in the same layer partial volume which is currently being irradiated with the light of the first wavelength. The light of the first wavelength (light section) and the light of the second wavelength (light projection) thus overlap spatially or in a projection plane of the projector 7 in a planar manner in a macroscopic layer partial volume of the starting material 3, which is currently irradiated by the light section, as the partial volume of the working volume 2.

In this way, at least one material property of the starting material 3 is changed in the currently irradiated layer-form partial volume, for example in that the original starting material is cured. In this case, polymerization can be triggered in the starting material 3 on account of the light of the two wavelengths coinciding. This for example makes it possible to produce a three-dimensionally shaped body layer-by-layer in the working volume 2. In this case, the three-dimensional shaping of the body is influenced and determined with the aid of the projection of the projector 7 imaged in the respective layer volume.

The method allows for adjustment to different volumes of the starting material 3. Furthermore, it allows for optimization between resolution and speed of processing.

A non-limiting example for the production of an optical element is given in the following: urethane dimethacrylate (Genomer 4247, 350 g), di-trimethylolpropane tetraacrylate (Miramer M410, 49 g), hexanediol diacrylate (Miramer M200, 4 g), N-methyl diethanolamine (4 g) and dual-color photoinitiator 1 (50 mg) are mixed homogeneously. The optical transmission of the resin thus resulting was determined by means of a Cary 50 UVVis spectrophotometer (Varian Inc.) at an optical path length of 10 mm to 69% at λ1=375 nm and to >99% at λ2=450-800 nm. The resin resulting in this way is transferred into a cuvette, which is optically processed according to the described method. The cured object is removed from the excess starting material and washed multiple times with isopropanol or other alcohols. The object can be post-cured, in that it is placed in a solution of isopropyl thioxanthone (ITX) in ethanol. The object is removed from the solution, dried in air, and cured using UV radiation (365 nm). At a thickness of 1 mm, the optical element exhibits an optical transmission of >90% at 450-1600 nm and has a surface roughness of <0.04 μm (Rₐ measured according to ISO 4288:199).

The dual-color photoinitiator 1 has the following structure:

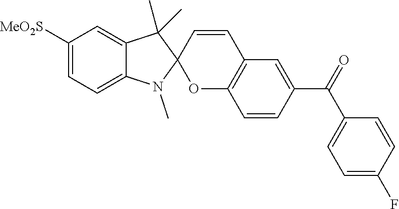 [SMILES: CN1c2ccc(S(C)(=O)=O)cc2C(C)(C)C12C=Cc1cc(C(=O)c3ccc(F)cc3)ccc1O2]

A further non-limiting example for the production of an optical element is given in the following: Urethane dimethacrylate (Genomer 4247, 120 g), tricyclo[5.2.1.02,6]decandimethanol diacrylate (Sartomer SR833S, 22.5 g), N-methyldiethanolamine (7.5 g), RHEOBYK-7420CA (BYK-Chemie GmbH, 5.2 g), 2,6-di-tert-butyl-4-methylphenol (BHT, 0.15 g), camphorquinone (0.15 g) and dual-color photoinitiator 2 (60 mg), are mixed homogeneously. The optical transmission of the resin thus resulting was determined by means of a Cary 50 UVVis spectrophotometer (Varian Inc.) at an optical path length of 10 mm to 69% at A1=375 nm and to >99% at A2=450-800 nm. The resin resulting in this way has non-Newtonian flow properties. The yield strength of the resin resulting in this way was determined after 24 h of stirring by means of rotational rheometry (Netzsch Kinexus Prime lab+ rotational rheometer, 20 mm plate-to-plate geometry, shearing stress ramp: dσ/dt=0.05 Pa/min, 25° C.) to σ=0.8 Pa. The resin resulting in this way is transferred into a container in the form of a cuvette, which is optically processed according to the described method. The cured object is removed from the excess starting material and washed multiple times with tripropylene glykol monomethyl ether and subsequently isopropanol. The object is subsequently removed from the respective washing solution, dried in air, and post-processed by means of irradiation with blue light (450 nm), in particular in order to cure it. At a thickness of 1 mm, the optical element exhibits an optical transmission of >90% at 400-1600 nm and has a surface roughness of <0.04 μm (Rₐ measured according to ISO 4288:199).

The dual-color photoinitiator 2 has the following structure:

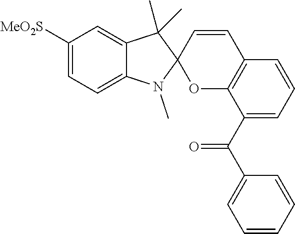 [SMILES: CN1c2ccc(S(C)(=O)=O)cc2C(C)(C)C12C=Cc1cccc(C(=O)c3ccccc3)c1O2]

When using ideal dual-color photoinitiators in the starting material 3, the excitation of the active state C takes place only in the case of absorption of both wavelengths A1 and A2 (first and second wavelength). For non-ideal photoinitiators, a transition from the intermediate state B into the active state C can also take place by absorption of the wavelength λ₁. Consequently, photoinitiators are transferred into the state C not only at the intersection point of the two wavelengths, but rather also along the entire light beam of the wavelength λ₁. Since there is no return path from the active state C of the photoinitiator into the basic state A, during processing of a plurality of desired target points a significant number of initiators in the active state C accumulate in undesired locations. The device makes it possible, in the overlap region of the light beams, to generate a sufficient initiator concentration, in the active state C, for the polymerization of the starting material, while simultaneously minimizing the generated concentration of initiator molecules in the active state C along the light beam of the first wavelength λ₁. Furthermore, the device makes it possible to minimize the accumulation of photoinitiators in the active state C in undesired regions of the volume, caused by the light overlap for a plurality of successive target points.

If the base state A exhibits an absorption band at the second wavelength λ₂, the photoinitiator can be transferred by light of the wavelength λ₂ into the intermediate state B and subsequently into the active state C. Consequently, photoinitiators are transferred into the state C not only at the overlap region of the two wavelengths, but rather also along the entire light beam of the wavelength λ₂. Since there is no return path from the active state C of the photoinitiator into the basic state A, during processing of a plurality of desired target points a significant number of initiators in the active state C accumulate in undesired locations. The device makes it possible, in the overlap region of the light beams, to generate a sufficient initiator concentration, in the active state C, for the desired modification of the starting material 3, while simultaneously minimizing the generated concentration of initiator molecules in the active state C along the light beam of the wavelength λ₂. Furthermore, the device should make it possible to minimize the accumulation of photoinitiators in the active state C in undesired regions of the volume, caused by the light overlap for a plurality of successive target points.

The device and the method can also be combined with other techniques which limit the undesired curing by accumulation of photoinitiators in the active state C. In one example, the oxygen concentration in the starting material can be set in order to vary the threshold value from which curing of the material occurs. In a further example, an inhibitor can be added to the starting material, in order to vary the threshold value from which curing of the material occurs.

Further aspects of the device for optical processing of the starting material 3 are explained in the following.

The starting material 3 can be received in a transparent vessel (receiving vessel 1) having at least two optically flat entry windows, which receives the starting material 3 with the added dual-color photoinitiator molecules or other optically active molecules, and optionally further additives such as co-initiators. The light source 5 configured as a light generator having imaging optics creates a light section of the wavelength λ₁, which is irradiated into the working volume 2 through a window of the receiving vessel 1. The projector 7 comprising a light source of the wavelength λ₂ creates an image which is imaged sharply in the receiving vessel 1 via an objective within the light section.

The refraction of the irradiated light of the second wavelength at the transitions between air and the receiving vessel 1 and between the receiving vessel 1 and the starting material 3 makes it possible for a displacement of the focal plane of the projected image (light of the second wavelength) to occur, with respect to the optical imaging without the receiving vessel 1. In the case of large working volumes of the receiving vessel 1, the depth of field of the focused projector images may not be sufficient. In this connection, a focus correction can then take place continuously during the movement of the light section through the working volume 2.

For applications in the field of 3D printing, the refractive index of the starting material 3 can be similar to the material of the receiving vessel 1. In this case, only the transition between air having a refractive index n₁ and the receiving vessel 1 having a refractive index n₂ leads to a displacement of the focal plane by the amount, Δs given by:

$$Δ s = d \cdot ( \frac{{n}_{2}}{{n}_{1}} - 1 )$$

With increasing distance d of the position of the light section (light of the first wavelength) from the entry window of the receiving vessel 1, where the projector image enters, the focus displacement increases according to the above equation. The equation relates to a paraxial, optical beam path or greater distances between the projector 7 and receiving vessel 1. Depending on the embodiment, a compensation of the displacement can take place by means of a motorized focus adjustment of the fixedly mounted projector 7 or by means of motorized positioning of the entire projector 7 relative to the light section position. In the last-mentioned example, a uniform, linear relative movement of the projector 7 relative to the fixed light section occurs, during the uniform movement of the receiving vessel 1 through the light section (layer partial volume) for processing the entire working volume 2.

Alternatively to the structure illustrated in FIG. 1, the projector image can also enter the working volume 2 through the base or the cover of the receiving vessel 1, and the light section can be coupled in perpendicularly thereto through one or more of the side windows.

Alternatively, the light section generator 5 can generate the wavelength λ₂, and the projector 7 generates the wavelength λ₁.

If the transition from the intermediate state B into the starting state A is intended to occur with light of the wavelength λ₃, the projector 7 generates the wavelengths λ₁ and λ₃ or the wavelengths λ₂ and λ₃, in each case complementary to the wavelength of the light section generator.

One or more light detectors 8a, 8b (camera or simple photodetector; cf. FIGS. 1 and 2) can be used in order to study the procedures during the processing, in that the transmitted light of the excitation of the light section and optionally of the projector 7 is measured. In this case the light section generator 5 and optionally also the projector 7 can emit further light wavelengths which are different from the excitation wavelengths and serve only for observing the change in the material property of the starting material 3, for example the polymerization.

Furthermore, a measurement of the emitted fluorescence of excited photoinitiators located in the starting material 3 can be provided. For example, the intensity of the entire transmitted or emitted light can be measured via a single photodetector, and/or the spatially resolved intensity can be recorded using a camera. The detectors can selectively measure, via preceding filters or spectrographs, only certain light wavelengths of the projector 7, of the light section generator 5, or of the light-emitting, excited photoinitiators.

The evaluation of the entire or spatially resolved intensities can control a control loop, which influences the intensity of the light section generator, the intensity and image output of the projector, the time control of the illumination sequence, and the displacement of the light section within the receiving vessel 1. For this purpose, a control device 9 is provided, which couples at the light source 5 and the projector 7, according to FIG. 1.

A laser light source can be used as the light source 5, for example a pulsable single-mode diode laser (manufacturer: IBEAM SMART, Toptica Photonics AG, DE) having a wavelength of 375 nm and an output power in continuous-wave operation of max. 70 mW, the laser beam diameter is 1.3 mm (@1/e²). An aspherical POWELL lens (fanning angle 30°, N-BK7, Edmund Optics GmbH, DE) serves for reshaping the laser beam into a divergent laser line. In one embodiment, a piano-convex cylinder lens arranged therebehind and having a long focal length (f=300.00 mm, N-BK7, Thorlabs GmbH, DE) and perpendicular orientation to the fanning plane generates a beam waist having a diameter of approximately d=100 μm at the position of the vessel comprising the starting material at a spacing of 30 cm from said lens. A piano-convex cylinder lens (f=150.00 mm, N-BK7, Thorlabs GmbH, DE) at a spacing of a single focal length from the POWELL lens collimates the divergent laser line and ensures an approximately parallel beam course along the optical axis, the height of the light section after collimation is approximately 8.5 cm. A further cylinder lens of focal length (f=100.00 mm, N-BK7) is flexibly positioned in front of the vessel, which lens transfers the beam path into a tapering light section, which reduces the drop in intensity due to the Beer-Lambert absorption law, within the vessel. The usable height of the light section in the region of the vessel due to the focusing is approximately 2 cm.

For reshaping a laser beam into a divergent laser line, alternatively to the POWELL lens a suitably arranged rotating polygon mirror or a galvo scanner can also be used. It is in principle also possible, instead of the laser, to use a light source which is based on an LED (light-emitting diode) or a thermal light source.

A DMD (digital micromirror device by the company Texas Instruments) based projector (manufacturer: optoma UHD35) having a resolution of 3840×2160 pixels and 3600 Ansi lumens can be used as the image projector or projector 7. The projection optics were replaced by a projection objective of 90 mm focal length (Braun Ultralit 2.4/90, Braun Photo Technik GmbH, Germany), which generates a sharp image within the vessel. A preceding filter glass (GG475, Schott AG, Germany) serves for wavelength selection. The actuation of the projector 7 takes place via an HDMI interface.

For example, a large cuvette made of optical glass (inside dimensions 30 mm×30 mm×30 mm, Hellma GmbH & Co. KG, Germany) having transparent, flat entry windows can be used as the receiving vessel 1.

FIG. 3a to 3c show schematic views for an arrangement comprising a receiving vessel 1, in which the working volume 2 having the starting material 3 received therein is arranged for optical processing. An arrangement of light sources 30 is provided. The light sources 30 (light generators for generating the light section 31) which serve for irradiation of the light of the first wavelength (light section) are arranged adjacently to the receiving vessel 1, in particular on opposing sides. In the embodiment according to FIG. 3c, the arrangement of light sources 30 around the receiving vessel 1 having the working volume 2 is rotatably arranged, which is shown schematically by arrows 32.

Two or more of the light sources 30 can be used, which irradiate into the working volume 2 from different, in particular opposing or non-opposing, sides of the receiving vessel 1, and generate the light section 31 by means of superimposition of partial beams, i.e. irradiate the respective layer partial volume into which the projection 33 then takes place.

The light section 31 for the layer partial volume just irradiated in each case results from the summation of the individual irradiations from the light sources 30 at different irradiation angles. In order to achieve a homogeneous intensity distribution of the light section 31 by means of superimposition of the light of two or more light sources, the individual irradiations can have a Gaussian or an adjusted inhomogeneous intensity distribution instead of a homogeneous intensity distribution.

In a further embodiment according to FIG. 4, two or more light sections 40 (layer partial volumes) are generated, which are incident into the receiving vessel 1 at an angle. One or more projection 41 from projectors (not shown in FIG. 4 for the sake of simplicity) create sharp images within the individual light sections 40, in an oblique focal plane. As a result, processing of a plurality of layer partial volumes can take place simultaneously.

In the embodiments according to FIG. 3a to 3c, 4, the receiving vessel 1 can be moved through the light section 31, 40, or the light section 31, 40 can be displaced when the receiving vessel 1 is in a fixed position, in order to continuously and ultimately completely process the working volume 2, in that the layer partial volumes thereof are optically processed in succession FIG. 5 shows schematic illustrations for a further arrangement comprising a receiving vessel 1. Both a light section 50 of the first wavelength and a projector image 51 of the second wavelength are created by means of a projection device 52 and then irradiated onto the receiving vessel 1. An arrangement of light reflection elements 53, in particular mirrors, ensures the separation of the light section 50 from a beam axis of the projection device 52 and the irradiation of the light section 50 transversely to the projection image 51 into the receiving vessel 1.

In one embodiment, the receiving vessel 1 can be moved, in order to move the light beam through the working volume 2. The projector image 51 is imaged sharply within the light section 50 by means of variable focus optics. In a further embodiment, the receiving vessel 1 remains immobile, and the light section 50 is moved in that a display element of the projection device 52, for example an LCD or a DMD display, is divided into a central region 54, which generates the projector image 51, and into two regions 55 mounted laterally thereof, which create the light section 50. For this purpose, pixels of the display element are actuated by means of controlling the optical transmission or reflection of the display element in such a way as to achieve a lateral shift of the light section 50. In this case, a central region of the display element is irradiated with the first wavelength, and outer regions of the display element are irradiated with the second wavelength.

FIG. 6 is a schematic view of a further arrangement for optical processing of the starting material 3 in the receiving vessel 1. FIG. 7 is a schematic partial view of the arrangement from FIG. 6.

A light section 60 is generated in a horizontal plane 61 by means of a laser beam 62, which enters from above into an immersion tube 63 that is optically transparent for the laser beam 62, and is deflected, by means of a motorized, rotating mirror 64, into the receiving vessel 1 comprising the starting material 3. Rotation results in the light section 60 of the first wavelength. Projector light 66 of the second wavelength is irradiated through a base 65 of the receiving vessel 1, in order to sharply image a projector image 67 in the horizontal plane 61 of the light section 60.

The immersion tube 63 is closed at the bottom. The motorized, rotating mirror 64 and the laser beam path 62 are separated from the starting material 3 in the receiving vessel 1. For processing the starting material 3, the immersion tube 63 is moved up or down, as a result of which the horizontal plane of the light section 60 is displaced up or down.

FIG. 8 is a schematic plan view (FIG. 8a) and side view (FIG. 8b) of a further arrangement for optical processing of the starting material 3 in the receiving vessel 1. The laser beam emanating from the laser 80 is deflected via a galvanometer scanner 81 through a lens 82 on a mirror ring 83, which results in a circular light section of the first wavelength. The light of the second wavelength is provided by a projector unit 84 and deflected into the receiving vessel 1 orthogonally to the light section, with the aid of a mirror 85.

Further aspects of the method for optical processing of the starting material 3 are explained in the following.

The local polymerization of the starting material 3, provided via the light excitation of the photoinitiators, takes place by means of a sequential method, in which processing takes place layer-by-layer in the free volume within the receiving vessel 1. For this purpose, it is first provided to dismantle the desired, three-dimensional object into individual layer images having a defined grid element spacing (slicing). By means of superimposition of the light section from the light source 5 and the respective sectional image of the projector 7, excitation of the dual-color photoinitiators takes place, from the basic state A into the active form C, which initiates the local polymerization of the starting material 3. After the lighting sequence for the current layer (layer partial volume) has been completed, the light excitation is displaced in a defined manner by movement of the receiving vessel 1 and/or the light section and the projector 7 together, and the lighting of an adjacent or any other layer (other layer partial volume) is carried out. The translation of the projection arrangement or of the receiving vessel 1, which can be achieved for example by means of suitable stepper motors, may possibly be below the waist diameter of the light section, in order to generate an increase of the resolution in the direction of movement.

There are various options for the temporal course of a lighting sequence for each layer partial volume, which are used depending on the starting material and the properties of the dual-color photoinitiators used:
Variant (1): simultaneous activation of both light sources (λ₁, λ₂ and optionally λ₃) with defined, optionally different, intensities for a predetermined illumination time period. After the simultaneous activation, the translation of the system to the next layer begins.
Variant (2): the first light source 5 (light section generator) and the projector 7 are operated in a temporally pulsed manner. The number, duration and intensity of the pulses, and the time offset between the starting flanks of the two pulses can be set freely in the context of a defined exposure time per layer partial volume. When using a plurality of pulses within the processing of one layer partial volume, each pulse can be associated with a different image of the projector 7. After the exposure time, the translation to the next layer partial volume takes place.
Variant (3): the first light source 5 (light section generator) remains constantly activated, while the projector image is switched after a defined exposure time with the translation of the arrangement to the next step.
Variant (4): physically possible combinations of variants (1), (2) and (3).

The volumetric method set out here generates the desired three-dimensional object by polymerization of the starting material 3 within the working volume 2 in a layer-wise manner, but leaves the basic structure of the starting material 3 unchanged. This is an advantage over methods which can process the starting material only in mutually separated layers. The layer-wise illumination makes the method in principle quicker than the polymerization of the starting material point-by-point.

Owing to the widening of the light section, a larger region of the working volume 2 can be processed simultaneously, and thus more quickly, which, however, means a loss of resolution.

The creation of the light section by means of the light source 5 requires coupling between the minimum waist diameter and the divergence of the bundle of rays, which leads to a widening of the light beam at the edge of the volume. As a result, either a homogeneous, average resolution along the light section can be generated, or a higher resolution in the region of the waist having a greater drop towards the edges.

Since in the temporal course earlier processing of layers is made possible, which are further from the projector 7, a possible influencing of the light propagation of the projector image (light of the second wavelength) by the already cured layers is avoided.

Owing to the shift of the light section, each layer partial volume is processed just once and thus obtains a defined energy dose. This effectively prevents the polymerization of undesired regions, in the case of use of non-ideal dual-color photoinitiators.

If the kinetics of the reactions of the photoinitiator molecules and the starting material 3, triggered by the light irradiation, is sufficiently known, the purposeful time control of the light pulses relative to one another and the suitable selection of the intensities of the two wavelengths allows for greater discrimination between desired and undesired polymerization in the working volume 2. As a result, artefacts and degradation of the resolution for non-ideal dual-color photoinitiators can be reduced.

The features disclosed in the above description, the claims, and the drawings may be relevant both individually and in any combination, for implementing the various embodiments.

Individual features of the invention are shown again by way of example in the following aspects:

1. Method for producing an optical element by processing an optically reactive material, comprising:
providing a starting material (3), which is optically reactive and fills a working volume (2); optically processing the starting material (3) in the working volume (2) by way of irradiation of light of a first wavelength and light of a second wavelength that is different from the first wavelength, wherein the light of the first wavelength and the light of the second wavelength are provided by a lighting device, wherein at least one material property of the starting material is changed by way of the optical processing, and wherein the optical processing comprises the following:
irradiating a first layer partial volume of the working volume (2) filled with the starting material (3) with the light of the first wavelength;
irradiating the first layer partial volume of the working volume (2) with the light of the second wavelength, wherein the light of the second wavelength is in this case projected, by a projection device (7), into the working volume (2) in a manner that hits only the first layer partial volume entirely or in part;
irradiating a second layer partial volume of the working volume (2) filled with the starting material (3), which is different from the first layer partial volume, with the light of the first wavelength;
irradiating the second layer partial volume of the working volume (2) with the light of the second wavelength, wherein the light of the second wavelength is in this case projected, by a projection device (7), into the working volume (2) in a manner that hits only the second layer partial volume entirely or in part; and repeating the preceding steps for layer-wise optical processing of the starting material (3) in the working volume (2) until a volume of the starting material (3) to be processed, which is gathered entirely or in part by the working volume (2), is optically processed, and in the process a green body is formed from the starting material (3); and further processing the green body, such that an optical element is formed at least in part from the green body.

2. Method according to aspect 1, wherein the further processing of the green body comprises at least one of the following steps: Removing the green body from the starting material, treating the green body with a solvent and/or a monomer; drying the washed green body; and photochemically and/or thermally post-curing the green body.

3. Method according to aspect 2, wherein the solvent and/or the monomer comprises a thermal initiator and/or a further photoinitiator which preferably reacts only at one wavelength.

4. Method according to at least one of the preceding aspects, wherein the further processing of the green body comprises at least one of the following steps:
photochemical post-curing of the green body, tempering the green body, grinding the green body, polishing the green body, and coating the green body.

5. Method according to at least one of the preceding aspects, wherein the light of the first wavelength and the light of the second wavelength are irradiated simultaneously and together into the first or the second layer partial volume, at least for a temporal overlap period, wherein preferably the light of the first wavelength is irradiated along a first irradiation direction, and the light of the second wavelength is irradiated along a second irradiation direction which extends transversely to the first irradiation direction, onto the starting material (3) in the working volume (2).

6. Method according to any of the preceding aspects, wherein a polychromic multi-photon polymerization is triggered in the starting material (3), by means of the optical processing, which causes the change in the at least one material property of the starting material (3).

7. Method according to at least one of the preceding aspects, wherein the starting material comprises a transparent organic polymer and/or an inorganic/organic polymer composite, which preferably cures by means of the optical processing.

8. Method according to at least one of the preceding aspects, wherein the starting material has a viscosity of 10² mPa·s to 10⁷ mPa·s.

9. Method according to at least one of the preceding aspects, wherein the formation of the optical element comprises the formation of at least one of an optical lens, a lens of imaging quality, an intraocular lens, a lens array, a diffusor, a prism, an optical grating, a diffractive optical element, and an optical waveguide.

10. Method according to at least one of the preceding aspects, wherein with the starting material (3) at least one functional element is provided, and the optical element is formed at least in part adjacently to the at least one functional element.

11. Method according to aspect 10, wherein the at least one functional element comprises at least one of the following elements: an actuator element, a sensor element, an energy source element, a display, a lens holder, and at least one prefabricated further optical element.

12. Method according to either aspect 10 or aspect 11, wherein the at least one functional element has a refractive index that deviates from a starting material refractive index by at most 3%.

13. Method according to at least one of aspects 10 to 12, wherein during optical processing the starting material is irradiated around the at least one functional element with light of the first wavelength and light of the second wavelength, from at least two sides.

14. Method according to at least one of the preceding aspects, wherein the irradiation with light of the first wavelength and/or light of the second wavelength takes place using a plurality of light sources (5), such that the light is irradiated into layer partial volumes which overlap at least in part.

15. Optical element produced by means of a method according to at least one of the preceding aspects.

1-47. (canceled)

48. Method for producing an optical element by processing an optically reactive material, comprising:
providing a starting material, which is optically reactive and fills a working volume;
optically processing the starting material in the working volume by way of irradiation of light of a first wavelength and light of a second wavelength that is different from the first wavelength, wherein the first wavelength is particularly less than or equal to 400 nm, in particular less than or equal to 375 nm, and/or wherein the second wavelength is particularly greater than 400 nm, preferably greater than 500 nm, wherein at least one material property of the starting material is changed by way of the optical processing, particularly via triggering a polychromic multi-photon polymerization in the starting material by means of the optical processing, which causes the change in the at least one material property of the starting material,
and wherein the optical processing comprises the following:
irradiating a first layer partial volume of the working volume filled with the starting material with the light of the first wavelength;
irradiating the first layer partial volume of the working volume with the light of the second wavelength, wherein the light of the second wavelength is in this case projected into the working volume;
irradiating a second layer partial volume of the working volume filled with the starting material, which is different from the first layer partial volume, with the light of the first wavelength;
irradiating the second layer partial volume of the working volume with the light of the second wavelength, wherein the light of the second wavelength is in this case projected into the working volume; and
repeating the preceding steps for layer-wise optical processing of the starting material in the working volume until a volume of the starting material to be processed, which is gathered entirely or in part by the working volume, is optically processed, and in the process a green body is formed from the starting material; and
further processing the green body, such that an optical element is formed at least in part, in particular completely, from the green body.

49. The method according to claim 48, wherein the further processing of the green body comprises at least one of the following steps:
removing the green body from the starting material;
treating the green body with a solvent and/or a monomer, wherein the solvent and/or the monomer particularly comprise a thermal initiator and/or a further photoinitiator which preferably reacts only at one wavelength;
drying the washed green body;
photochemically and/or thermally post-curing the green body;
tempering the green body;
grinding the green body;
polishing the green body;
coating the green body;
treating the green body with a solvent and/or a monomer, in particular for washing the green body, wherein a solvent and/or a monomer having a molar mass of greater than or equal to 200 g/mol is used;
treating the green body with a solvent and/or a monomer, in particular for washing the green body, wherein a highly volatile solvent and/or a highly volatile monomer is used; and/or
wherein the further processing of the green body, such that an optical element is formed at least in part, in particular completely, from the green body, in particular the post-curing of the green body, is carried out under a protective gas atmosphere, in particular an argon, carbon dioxide or nitrogen atmosphere; and/or
wherein the further processing of the green body comprises photochemical post-curing of the green body by means of at least one additional photoinitiator, wherein the additional photoinitiator is configured to perform a photochemical reaction, in a wavelength different from the first and the second wavelength, that causes photochemical post-curing of the green body;
wherein optionally, the additional photoinitiator is an alpha-diketone, in particular camphorquinone, or contains at least one alpha-diketone, in particular camphorquinone, and/or wherein, optionally, the additional photoinitiator is irradiated with a wavelength that is between the first and the second wavelength.

50. The method according to claim 48, wherein the light of the first wavelength and the light of the second wavelength are irradiated simultaneously and together into the first or the second layer partial volume, at least for a temporal overlap period, wherein preferably the light of the first wavelength is irradiated along a first irradiation direction, and the light of the second wavelength is irradiated along a second irradiation direction which extends transversely to the first irradiation direction, onto the starting material in the working volume; and/or wherein a polychromic multi-photon polymerization is triggered in the starting material, by means of the optical processing, which causes the change in the at least one material property of the starting material.

51. The method according to claim 48, wherein the starting material comprises a transparent organic polymer and/or an inorganic/organic polymer composite, which preferably cures by means of the optical processing, and/or wherein the starting material has a viscosity of 10² mPa·s to 10⁷ mPa·s and/or a yield strength of at least 0.1 Pa.

52. The method according to claim 48, wherein the formation of the optical element comprises the formation of at least one of an optical lens, a lens of imaging quality, an intraocular lens, a lens array, a diffusor, a prism, an optical grating, a diffractive optical element, and an optical waveguide.

53. The method according to claim 48, wherein with the starting material at least one functional element is provided, and the optical element is formed at least in part adjacently to the at least one functional element, wherein the at least one functional element comprises at least one of the following elements: an actuator element, a sensor element, an energy source element, a display, a lens holder, and at least one prefabricated further optical element; and/or wherein the at least one functional element has a refractive index that deviates from a starting material refractive index by at most 3%; and/or wherein during optical processing the starting material is irradiated around the at least one functional element with light of the first wavelength and light of the second wavelength, from at least two sides.

54. The method according to claim 48, wherein the irradiation with light of the first wavelength and/or light of the second wavelength takes place using a plurality of light sources, such that the light is irradiated into layer partial volumes which overlap at least in part.

55. The method according to claim 48, wherein it is determined whether the first or the second layer partial volume is irradiated with the first wavelength, and a projection device for projecting the light of the second wavelength into the working volume is actuated, depending thereon, to project the light of the second wavelength into the first or into the second layer partial volume, in particular in a specific intensity distribution.

56. The method according to claim 48, wherein the light of the first wavelength and the light of the second wavelength are irradiated simultaneously and together into the first or the second layer partial volume, at least for a temporal overlap period.

57. The method according to claim 48, wherein the first and the second layer partial volume form adjacent layer partial volumes of the starting material in the working volume, wherein optionally the first and the second layer partial volume are formed corresponding to one of the following configurations of partial volumes: overlapping at the edge, abutting at the edge, and spaced apart from one another at the edge.

58. The method according to claim 48, wherein the light of the first wavelength is irradiated by means of a plurality of light generators for creating a light section, which irradiate into the working volume from different sides of a working vessel comprising the working volume, and generate the light section, in which the projection takes place, by means of superimposition of partial beams; and/or
wherein the light of the first wavelength is irradiated by means of four light generators for creating a light section, which, in particular located opposite one another in pairs, irradiate into the working volume from different sides of a working vessel comprising the working volume, and generate the light section, in which the projection takes place, by means of superimposition of partial beams.

59. The method according to claim 48, wherein at least two differently oriented light sections are created, in particular at least two differently oriented light section which overlap in the working volume.

60. The method according to claim 48, wherein for creating the light section in the working volume the light of the first wavelength is irradiated into the working volume with a rotational movement.

61. The method according to claim 48, wherein the light of the first wavelength is irradiated first in the first layer partial volume and then in the second layer partial volume with a distribution that is substantially homogeneous or non-homogeneous with respect to at least one of the following light parameters: light intensity and light color.

62. The method according to claim 48, wherein a light section is created in the working volume, in particular a light section of the light of the first wavelength, and during the movement of the light section through the working volume a focus correction, in particular a focus correction of the light of the second wavelength, takes place continuously.

63. The method according to claim 48, wherein the optical element to be produced has a main extension plane having a planar geometric shape, wherein the construction direction of the optical element is selected to be at an angle, in particular at a right angle, to the main extension plane.

64. The method according to claim 48, wherein at least one first irradiation device is used, which is configured such that it irradiates light of the first wavelength into the working volume in order to create at least one first light projection in the working volume, wherein the at least one first light projection comprises a plurality of light beams which pass through the working volume in at least one light plane; and
at least one light modulation device is used, which is associated with the at least one first irradiation device, wherein the at least one light modulation device is configured such that it modulates the spatial extension direction of two or more light beams of the plurality of beams in the at least one light plane in such a way that the two or more light beams extend in a non-parallel arrangement relative to one another; wherein the at least one light modulation device particularly comprises one or more optical elements, wherein each optical element is configured such that it changes the original spatial extension direction of the incident light beam, in order to create a light beam that has a different spatial extension direction relative to the original spatial extension direction.

65. The method according to claim 48, wherein at least one measure for changing the optical properties of the green body is carried out, wherein
the at least one measure preferably includes at least one of:
changing the optical properties of the green body, which leads to a reduction in the absorption properties of the green body for at least a wavelength in a wavelength range between 300 nm and 2000 nm, in particular between 350 nm and 900 nm, and/or to an increase in the permeability properties of the green body for at least a wavelength in the wavelength range between 300 nm and 2000 nm, in particular in the wavelength range between 350 nm and 900 nm, in particular in the wavelength range between 400 nm and 800 nm, and/or
a thermal treatment of the green body and/or optical treatment of the green body, in particular by irradiating the green body using electromagnetic radiation, and/or chemical treatment of the green body.

66. The method according to claim 48, wherein the starting material is transparent, particularly wherein the starting material has, in particular in a wavelength range between 370 and 800 nm, in particular between 400 and 800 nm, further in particular between 450 and 800 nm, a transmission of at least 30%, in particular at least 50%, further in particular at least 80%, further in particular at least 90% in the range of the irradiated light of the first wavelength and/or in the range of the irradiated light of the second wavelength.

67. The method according to claim 48, wherein the starting material has a non-Newtonian rheological behavior.
